(19) United States
(12) Patent Application Publication
(10) Pub. No.: US 2025/0306427 A1
(43) Pub. Date: Oct. 2, 2025

(54) TECHNOLOGIES FOR PROGRAMMABLE MICRORING RESONATORS

(71) Applicant: Intel Corporation, Santa Clara, CA (US)

(72) Inventors: Seyed Hamed Shams Mousavi, Albuquerque, NM (US); Olufemi I. Dosunmu, San Jose, CA (US); Saeed Fathololoumi, Los Gatos, CA (US); Paul J. Martin, Albuquerque, NM (US)

(21) Appl. No.: 18/620,866

(22) Filed: Mar. 28, 2024

(51) Int. Cl. G02F 1/225; G02F 1/01; G02F 1/035; G02F 1/21

(52) U.S. Cl. CPC G02F 1/2257; G02F 1/0147; G02F 1/035; G02F 1/218

(57) ABSTRACT

Techniques for programmable microring resonators are disclosed. In an illustrative embodiment, microring resonator is coupled to a waveguide. Due to process variations, the coupling rate between the microring resonator and the waveguide can vary. In order to tune the coupling regime between the microring resonator and the waveguide, a diode that forms part of the microring resonator can be forward biased, increasing the free carrier density and absorbing some of the light in the microring resonator. The forward biased diode can be used for various applications, such as to control the quality factor of the microring resonator, control a chirp on the light, and/or impart a blueshift to the microresonator.

### BACKGROUND

Silicon photonics (SIP) technology is used for high-data-rate transceiver (transmitter and receiver) modules and optical interconnects. SIP is also widely regarded as the leading candidate for the development of the next generation integrated quantum photonic technologies for low cost, compact and scalable realization of quantum networks and schemes previously demonstrated using fiber-optics and free-space optics platforms. Modulators using Mach-Zehnder interferometers are a common choice for silicon photonics. However, Mach-Zehnder modulators have certain drawbacks, such as relatively high power consumption and a large footprint. Microring modulators are a competing technology to modulators using Mach-Zehnder interferometers. Microring modulators (MRMs) can have high efficiency, compact size, and low power consumption. One important parameter for microring modulators is the coupling rate, which critically depends on the distance between the microring modulator and a waveguide bus. The balance between this coupling rate and the rate of optical loss inside the microring determines many performance metrics of the microring modulator. Small process deviations can lead to a change in both the coupling rate and the rate of optical loss inside the microring and can adversely affect these performance metrics.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a perspective view of one embodiment of a microring modulator.

FIG. 2 illustrates a cross-sectional view of the microring modulator of FIG. 1.

FIG. 3 illustrates a top-down view of one embodiment of a microring modulator.

FIG. 4 illustrates a top-down view of one embodiment of a microring modulator.

FIG. 5 illustrates a top-down view of one embodiment of a microring modulator.

FIG. 6 illustrates a top-down view of one embodiment of a microring modulator.

FIG. 7 illustrates a top-down view of one embodiment of a microring modulator.

FIG. 8 illustrates a top-down view of one embodiment of a microring modulator.

FIG. 9 is an isometric view of a system including an integrated circuit package with a photonic integrated circuit (PIC) die.

FIG. 10 is a cross-sectional view of one embodiment of the integrated circuit package of FIG. 9.

FIG. 11 illustrates a simplified block diagram of one embodiment of an optical communication device.

FIG. 12 is a simplified flow diagram of at least one embodiment of a method for creating microring resonators.

FIG. 13 is a simplified flow diagram of at least one embodiment of a method for operating microring resonators.

FIG. 14 is a top view of a wafer and dies that may be included in a microelectronic assembly, in accordance with any of the embodiments disclosed herein.

FIG. 15 is a cross-sectional side view of an integrated circuit device that may be included in a microelectronic assembly, in accordance with any of the embodiments disclosed herein.

FIGS. 16A-16D are perspective views of example planar, gate-all-around, and stacked gate-all-around transistors.

FIG. 17 is a cross-sectional side view of an integrated circuit device assembly that may include a microelectronic assembly, in accordance with any of the embodiments disclosed herein.

FIG. 18 is a block diagram of an example electrical device that may include a microelectronic assembly, in accordance with any of the embodiments disclosed herein.

### DETAILED DESCRIPTION OF THE DRAWINGS

Microring modulators in a silicon photonic integrated circuit can modulate an optical signal at high rates, exceeding 100 gigabits per second. However, a microring modulator is sensitive to the distance between the microring modulator and the bus waveguide it is coupled to. The distance between the microring modulator and the bus waveguide influences the coupling rate to the microring modulator. If the coupling rate from the bus waveguide to the microring modulator is equal to the loss rate in the microring modulator, then the bus waveguide is critically coupled, and a high extinction ratio can be achieved for light at the resonance frequency of the microring modulator. If the distance between the bus waveguide and the microring modulator is closer than the critical coupling distance, the microring modulator is overcoupled. If the distance between the bus waveguide and the microring modulator is farther apart than the critical coupling distance, the microring modulator is undercoupled. In either case, the extinction ratio is reduced, which can impact parameters such as the bit error rate (BER).

In an illustrative embodiment, in order to allow for the coupling to be tuned, a semiconductor junction that forms part of the microring modulator can be forward biased, increasing the charge density in part of the microring modulator and reducing the quality factor of the microring modulator. Reducing the quality factor has the effect of shifting the microring modulator towards an undercoupled regime. In this manner, the coupling regime of a microring resonator can be controlled.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

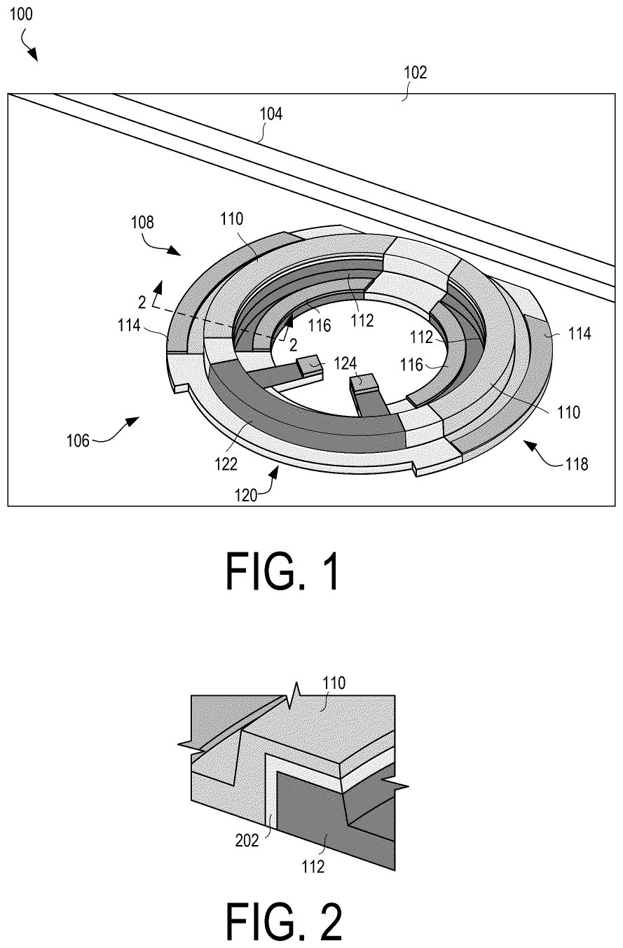

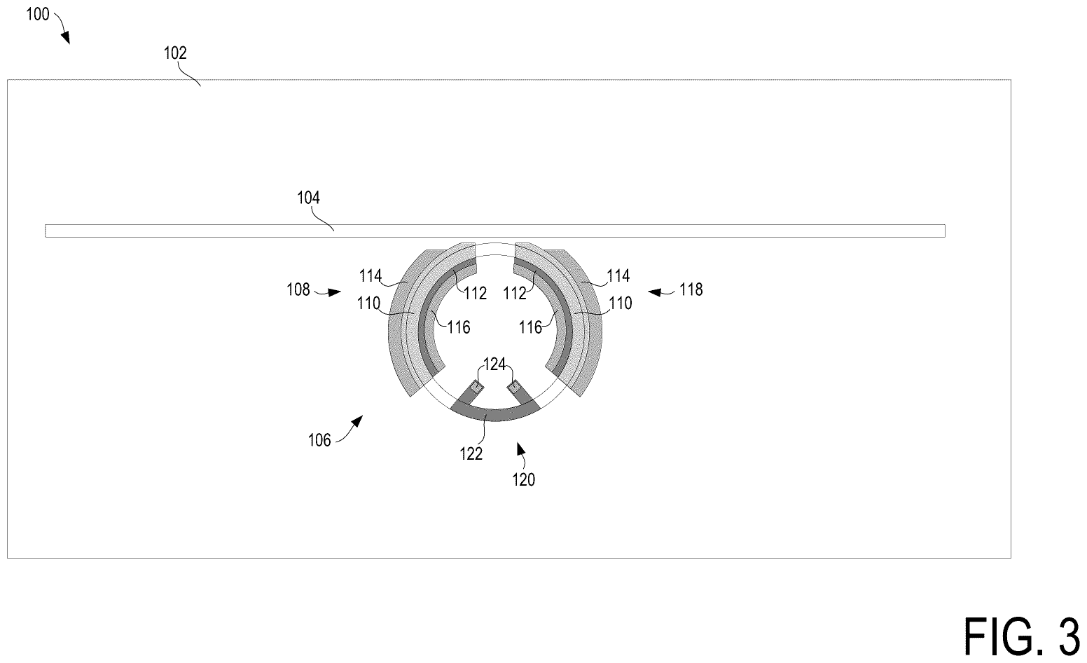

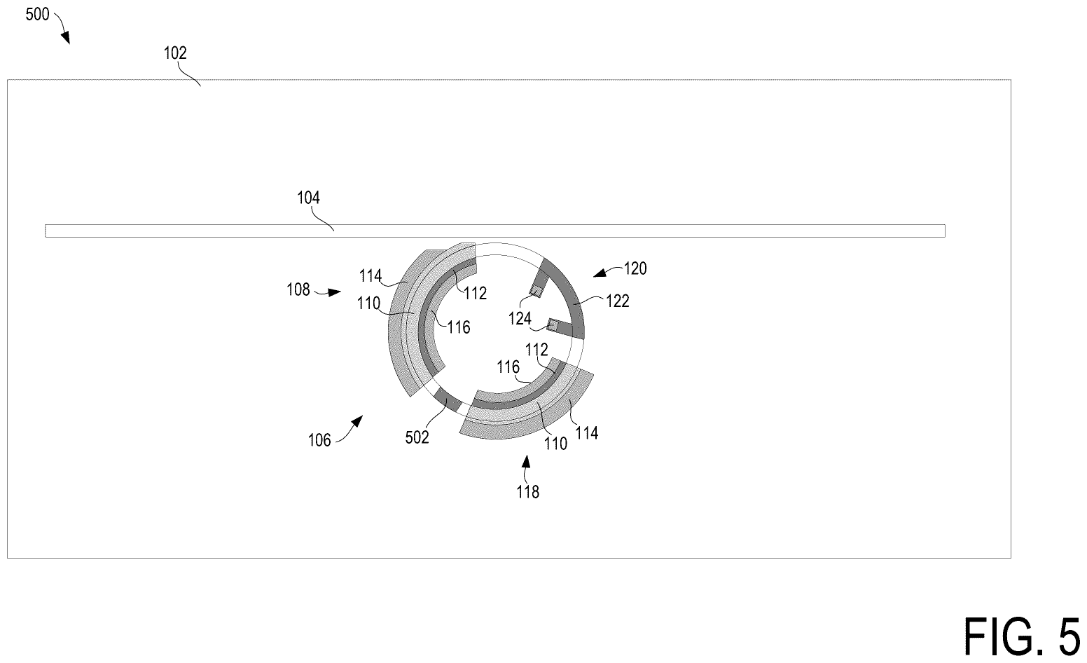

Referring now to FIGS. 1-3, in one embodiment, a photonic integrated circuit (PIC) die 100 includes a substrate 102, a bus waveguide 104, and a microring resonator 106. FIG. 1 shows a perspective view of the PIC die 100, FIG. 2 shows a cross-sectional view of one embodiment of the microring resonator 106, and FIG. 3 shows a top-down view of the PIC die 100. The microring resonator 106 is coupled to a mode of light in the waveguide 104. In the illustrative embodiment, the microring resonator 106 includes a first diode 108, a second diode 118, and a heater 120. Each of the diodes 108, 118 includes one or more n-doped portions 110 and one or more p-doped portions 112, forming one or more p-n junctions in the microring resonator. A depletion region 202 (see FIG. 5) is formed at the interface between the n-doped portion 110 and the p-doped portion 112. A bias electrode 114 is connected to each n-doped portion 110, and another bias electrode 116 is connected to each p-doped portion. A heater 120 can be used to tune the temperature of the microring resonator 106. The heater 120 includes a resistive region 122 and electrodes 124.

In use, in the illustrative embodiment, light in the waveguide 104 that is on resonance with the microring resonator 106 will be coupled to the microresonator ring 106. Depending on the coupling rate, the waveguide 104 may be undercoupled, critically coupled, or overcoupled to the microring resonator 106. In an illustrative embodiment, the distance between the waveguide 104 and the microring resonator 106 and other parameters of the system are such that the waveguide 104 is overcoupled to the microring resonator 106 before any tuning is applied.

In order to control the coupling regime, the diode 118 can be forward biased, injecting current into the depletion region 202 of the junction. The current absorbs some of the light, increasing the loss in the microring resonator 106, which lowers the quality factor of the microring resonator 106 and also shifts the coupling between the waveguide 104 and the microring resonator 106 towards an undercoupled regime. In this manner, the diode 118 acts as a variable optical attenuator. The bias forward biases the p-n junction of the diode 118 by any suitable voltage, such as 1-5 volts. With the proper current density at the junction, the coupling can be tuned from overcoupled to critically coupled to undercoupled. For example, a regime near critical coupling may be desired for increasing the extinction ratio between the modulator 106 being “off” and “on.” Other applications are considered as well below in more detail.

In addition to a voltage across the diode 118, a time-varying reverse vias voltage can be applied across the diode 108. The time-varying signal modulates the voltage across the p-n junction formed by the n-doped portion 110 and the p-doped portion 112, changing the electron density at the depleted region 202. The change in electron density changes the index of refraction of part of the microring resonator 106, shifting the resonance frequency of the microring resonator 106. As the p-n junction is reverse biased, only a small current flows through the p-n junction. Additionally or alternatively, in some embodiments, a different phase shifter may be using, such a lithium niobate or other phase-shifters based on the Pockels effect, an indium-tin-oxide (ITO)-based phase shifter, and/or the like. In use, a current may be passed through the heater 120 to control the temperature of the microring resonator 106. The heater 120 may be used for slowly tuning a resonance of the microring resonator 106 to a desired point.

In use, a light source couples light into the waveguide 104 that is at or a near a resonance of the microring resonator 106. Light that is at the resonance frequency of the microring resonator 106 is coupled into it and lost from the waveguide 104. As discussed above, the current through the forward-biased diode 118 can tune the microring resonator 106 to be critically coupled to the waveguide 104, so the light can be coupled out of the waveguide 104 with a high extinction ratio, such as −20 to −60 dB. The time-varying signal applied to the bias electrodes 114, 116 of the diode 108 can control the resonance of the microring resonator 106, controlling whether the light in the waveguide 104 is coupled into the microring resonator 106. As a result, the time-varying signal applied to the reverse biased diode 108 can modulate the intensity of the light passing through the waveguide 104. The microring modulator 106 can modulate the light at any suitable rate, such as 10-50 gigahertz. The microring modulator 106 be used to send data at any suitable rate, such as 1-100 gigabits per second. The microring modulator 106 may be used with any suitable modulation, such as 2-level or 4-level pulse amplitude modulation. The voltage applied to the electrodes 114, 116 of the diode 108 to shift the resonance of the microring resonator 106 may be any suitable voltage, such as 1-5 volts.

In an illustrative embodiment, the substrate 102 is silicon. In other embodiments, the substrate 102 may be a different material, such as silicon oxide, gallium arsenide, glass, another semiconductor, etc. In addition to the waveguide 104 and microring modulator 106, the PIC die 100 may include active or passive optical elements such as splitters, couplers, filters, optical amplifiers, lasers, photodetectors, modulators, etc. The PIC die 100 may include additional components, such as traces of copper or other conductors connected to active components such as the lasers microring modulator 106. The PIC die 100 may have any suitable length or width, such as 1-300 millimeters. The PIC die 100 may have any suitable thickness, such as 0.05-5 millimeters.

In the illustrative embodiment, the waveguide 104 and microring resonator 106 are made of silicon. In other embodiments, other suitable materials may be used. For example, in some embodiments, the microring resonator 106 may be made of another semiconductor, such as gallium arsenide, indium phosphide, etc. Additionally or alternatively, the waveguide 104 may be made of a material besides silicon, such as silicon nitride, silicon oxide, indium phosphide, polymer, chalcogenide, lithium niobate, etc.

In the illustrative embodiment, the waveguide 104 is straight in the region in which it interacts with the microring resonator 106. In other embodiments, the waveguide 104 may have another shape. For example, the waveguide 104 may be curved, following the curvature of the microring resonator 106, which may increase a coupling between the waveguide 104 and the microring resonator 106.

It should be appreciated that, in some embodiments, the waveguide 104 may be a different material from the microring resonator 106, and the waveguide 104 may be formed at a different process step than the microring resonator 106. For example, the waveguide 104 may be made of a non-semiconductor material with low loss, such as silicon nitride, and the microring resonator 106 may be made of a semiconductor with higher loss, such as gallium arsenide or indium phosphide. In such embodiments, the tolerance for the distance between the microring resonator 106 and the waveguide 104 may not be as tight as when the microring resonator 106 and the waveguide 104 are the same material and, therefore, can be created in the same process step. As such, in embodiments with different materials for the waveguide 104 and the microring resonator 106, tuning the coupling regime using the forward-biased diode 118 can be particularly useful.

The distance between the waveguide 104 and the microring resonator 106 may depend on various factors, such as the desired coupling rate between the waveguide 104 and the microring resonator 106, a geometry of the waveguide 104 and/or microring resonator 106 in an interaction region, the materials of the waveguide 104 and/or microring resonator 106, etc. In an illustrative embodiment, the distance between the waveguide 104 and the microring resonator 106 may be, e.g., 100-300 nanometers. The process variations for the distance between the waveguide 104 and the microring resonator 106 may depend on the particular process used and may be, e.g., a few nanometers up to 10-50 nanometers. For example, for a silicon waveguide 104 and silicon microring resonator 106 formed at the same process step, the variation in distance between the waveguide 104 and the microring resonator 106 may be, e.g., 1-5 nanometers, while for a silicon nitride waveguide 104 and gallium arsenide microring resonator 106 formed at different process steps, the variation in distance between the waveguide 104 and the microring resonator 106 may be, e.g., 10-50 nanometers.

The waveguide 104 may be a ridge waveguide, rib waveguide, or other suitable waveguide. In the illustrative embodiment, the wavelength of the light being modulated is about 1,305 nanometers. In other embodiments, the wavelength may be any suitable wavelength, such as 1,100-1,600 nanometers. The power of the light in the waveguide 104 may be any suitable amount, such as 1 microwatt to 50 milliwatts.

In the illustrative embodiment, the microresonator 106 is a microring with a radius of about 10 micrometers. In other embodiments, microrings with a different radius may be used, such as 5-20 micrometers. In still other embodiments, microresonators other than microring resonators may be used, such as microdisk resonators, microsphere resonators, racetrack resonators, etc.

The various electrodes 114, 116, 124 may be any suitable conductive material, such as copper, polysilicon, aluminum, etc. In some embodiments, the electrodes 114, 116, 124 may be connected to traces, vias, or other electrical interconnects on the substrate 102 or on one or more build-up layers formed on the substrate 102. In some embodiments, the various electrodes 114, 116, 124 may be connected via wire bonding to other components.

In the illustrative embodiment, the heater 120 forms part of the microring resonator 106. The heater 120 may be a p-doped or n-doped region with a relatively low resistance. In other embodiments, the heater 120 may be a resistor near the microring resonator 106 that is not part of the microring resonator 106. For example, the heater 120 may be a metallic microheater that is above the microring resonator 106 and/or waveguide 104, without or without a undercut.

In an illustrative embodiment, each diode 108, 118 includes a P-N junction where an n-doped region 110 meets a p-doped region 112, forming a depletion region 202. In some embodiments, one or both diodes 108, 118 may be embodied as a different type of junction, such as a P-I-N junction, with an intrinsic undoped region between the n-doped region 110 and the p-doped region 112. For example, the diode 108, which is reverse biased in use, may be embodied as a P-N junction, and the diode 118, which is forward biased in use, may be embodied as a P-I-N junction. The junction may have any suitable shape and orientation, such as perpendicular to the direction of light travel in the microring resonator 106, parallel to the direction of light travel in the microring resonator 106, in the plane of the microring resonator 106, perpendicular to the plane of the microring resonator 106, etc. Various possible embodiments of the diodes 108, 118 are described below in more detail in regard to FIGS. 3-8.

In the illustrative embodiment, modulation is performed by varying the reverse biased voltage across the diode 108. When the microring resonator 106 is on resonance with the light in the waveguide 104, it is absorbed by the microring resonator 106. The microring resonator 106 may absorb any suitable amount of the light in the waveguide 104, such as attenuating the light in the waveguide 104 by 10-60 dB. When the microring resonator 106 is off resonance with the light in the waveguide 104, the light is not absorbed. As the diode 108 can control whether the microring resonator 106 is resonant or off resonant with the light in the waveguide 104, the diode 108 can modulate the amplitude of the light in the waveguide 104. The diode 108 may shift the resonance of the microring resonator 106 by any suitable amount, such as 0.01-2 nanometers. In other embodiments, modulation may be done in a different manner, such as using any suitable linear or nonlinear electrooptic effect.

In the illustrative embodiment, tuning of the coupling regime between the waveguide 104 and the microring resonator 106 is performed by varying the forward bias across the diode 118 to change the quality factor of the microring resonator 106. The intrinsic quality factor can depend on various factors, and the target intrinsic quality factor may depend on the desired use case. In general, the intrinsic quality factor may be, e.g., 103-107. When a small or no current is passing through the junction of the diode 118, a relatively small amount of light in the microring resonator 106 is absorbed, allowing for a high quality factor, such as a quality factor that is limited by the intrinsic quality factor. When a large current is passing through the junction of the diode 118, a relatively large amount of light in the microring resonator 106 can be absorbed, which can significantly impact the quality factor. For example, the quality factor may drop from, e.g., 10³-10⁷ to 10².

In use, the forward-biased diode 118 can perform various functions, depending on the design and operation of the forward-biased diode 118. As discussed above, the forward-biased diode 118 can tune the coupling regime between the waveguide 104 and the microring resonator 106. One advantage of this ability is improved manufacturing yield. For example, if multiple microring resonators 106 are fabricated on the same wafer or die, manufacturing tolerances may result in slightly different coupling regimes for the various microring resonators 106, potentially limiting the performance of some or all of the microring resonators 106. With the ability to tune the coupling regime of each individual microring resonator 106, the performance of the various microring resonators 106 can be ensured.

In another use case, the forward-biased diode 118 can be used to tune the chirp on the modulated light. In use, the microring modulator 106 does not only modulate the amplitude of the light but also modulates the phase, putting a chirp on the modulated light. The parameters of the chirp can depend on the coupling regime. For example, a slightly undercoupled microring resonator 106 will impart a different phase than a slightly overcoupled microring resonator 106. The forward-biased diode 118 can be used to control the chirp on the modulated light. The chirp can, e.g., pre-compensate for any dispersion in an optical fiber that the modulated light is coupled to. The amount of dispersion in the optical fiber depends on the length of the optical fiber. In some embodiments, the forward-biased diode 118 can be used to dynamically control the amount of the chirp to correct for the amount of dispersion that will be caused by the optical fiber depending on the length of the optical fiber.

In another use case, the ability of the forward-biased diode 118 to lower the quality factor of the microring resonator 106 can be used to allow for a tradeoff between the optical bandwidth of the resonance peak of the microring resonator 106 and the modulation speed of the microring resonator 106. In general, a lower quality factor allows for higher optical bandwidth operation at the expense of lower modulation speed, and a higher quality factor allows for higher modulation speed at the expense of lower optical bandwidth operation. Tuning the quality factor by tuning the forward-biased diode 118 allows for tuning the tradeoff between those two parameters. It should be appreciated that the tradeoff can either be set statically, such as by setting a fixed voltage on the forward-biased diode 118 at manufacture time to allow for a particular optical bandwidth and modulation speed, or the tradeoff can be set dynamically, such as by changing the voltage on the forward-biased diode 118 during operation of the device, allowing the same microring resonator 106 to operate in different modes of operation.

In another use case, the forward-biased diode 118 can be used to compensate for baseline wandering. Baseline wandering can be a key limitation in performance of a microring resonator 106. Baseline wandering refers to the slow variation or drift in the baseline (zero level) of the modulated signal over time. This variation can occur due to several linear and nonlinear factors, such as thermo-optic effects. Baseline wandering can lead to shifts in the resonance frequency and signal distortion as well as reduction in performance metrics such as transmitter and dispersion eye closure quaternary (TDECQ), transmitter dispersion penalty (TDQ), and bit error rate (BER). Correcting for baseline wandering requires a tuning mechanism to change the transfer function of the microring resonator 106 after fabrication. In an illustrative embodiment, the forward-biased diode 118 can be used to increase the charge density in the junction of the forward-biased diode 118, decreasing the index of refraction and blueshifting the resonance of the microring resonator 106. Controllable blueshifting of the resonance of the microring resonator 106 can be used to compensate for effects such as baseline wandering at higher power levels, which tends to induce a redshift in the microring resonator 106.

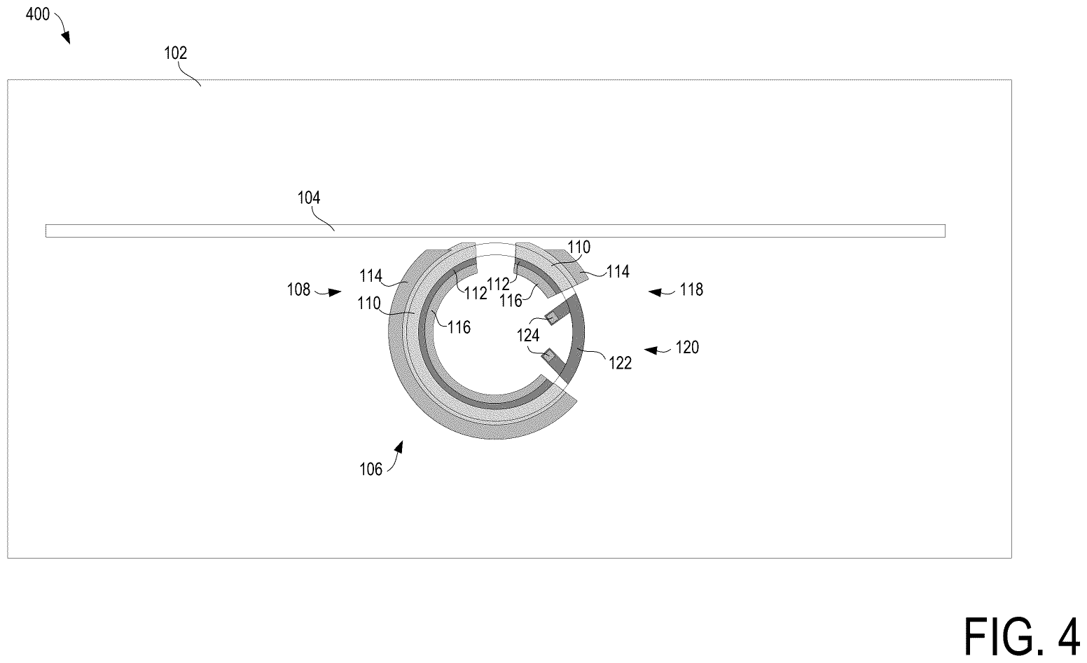

Referring now to FIG. 4, in one embodiment, a PIC die 400 may include diodes 108, 118 that may extend along different lengths of the microring resonator 106. For example, as shown in the figure, the diode 108 that is reverse biased may extend around about 60% of the circumference of the microring resonator 106, and the diode 118 that is forward biased may extend around about 10% of the circumference of the microring resonator 106. In general, each diode 108, 118 may extend around, e.g., 5-80% of the circumference of the microring resonator 106. The area that each diode 108, 118 extends around may influence how the diode 108, 118 impacts the microring resonator 106. For example, a reverse-biased diode 108 that extends along a longer segment of the microring resonator 106 can reduce the charge density over a larger distance at the same voltage, increasing the shift of the resonance of the microring resonator 106 caused by the reverse-biased diode 118.

Similarly, a forward-biased diode 118 that extends along a longer segment of the microring resonator 106 can impart the same blueshift at a lower free carrier density compared to a shorter segment. As a lower free carrier density can be achieved at a lower voltage, a forward-biased diode 118 that extends along a longer segment of the microring resonator 106 can impart the same blueshift at a lower voltage and less heating. Heating caused by the forward-based diode 118 can cause a redshift that partially or fully cancels out the blueshift caused by the increased free carrier density. As a result, how much blueshift the forward-biased diode 118 imparts can be tuned independently of how much the forward-biased diode 118 changes the quality factor of the microring resonator 106. A shorter forward-biased diode 118 can have heating that offsets some or all of the blueshift, and a longer forward-biased diode 118 can have a more pronounced blueshift.

Referring now to FIG. 5, in one embodiment, a PIC die 500 may include an isolation region 502 that may separate the diode 108 and the diode 118. The isolation region 502 may be an area of high resistance to prevent cross-talk between the diodes 108, 118. In an illustrative embodiment, the isolation region 502 may include alternating p-doped and n-doped semiconductor regions to prevent current flow.

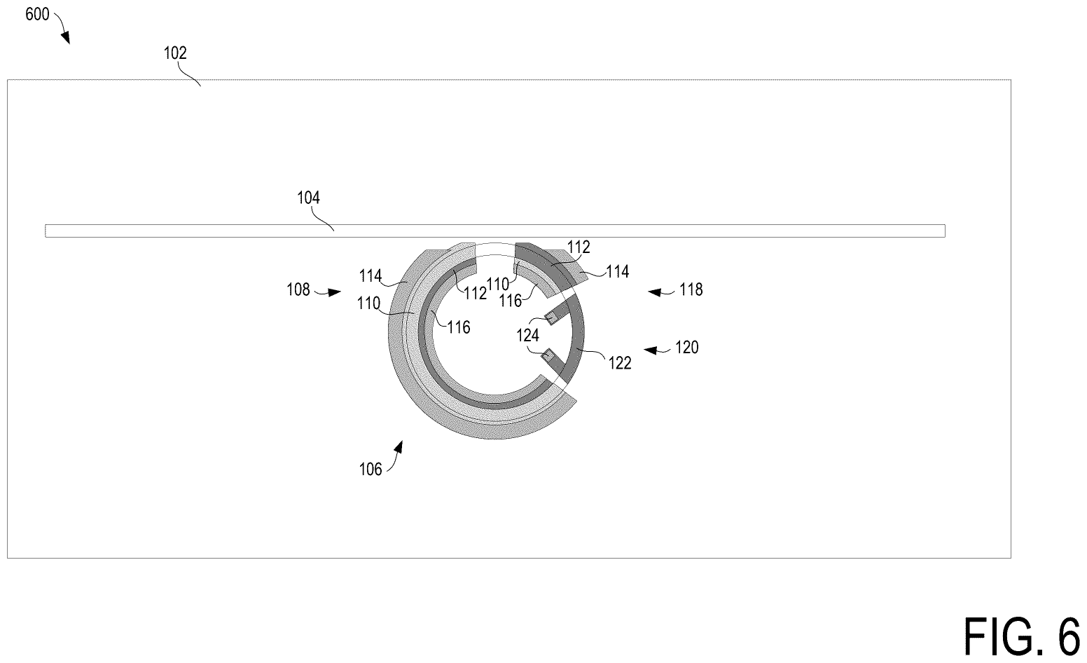

Referring now to FIG. 6, in one embodiment of a PIC die 600, the n-doped region 110 of the diode 108 may be on the outer portion of the microring resonator 106, and the p-doped region 112 of the diode 108 may be on the inner portion of the microring resonator 106, while the n-doped region 110 of the diode 118 may be on the inner portion of the microring resonator 106, and the p-doped region 112 of the diode 118 may be on the outer portion of the microring resonator 106, as shown in the figure.

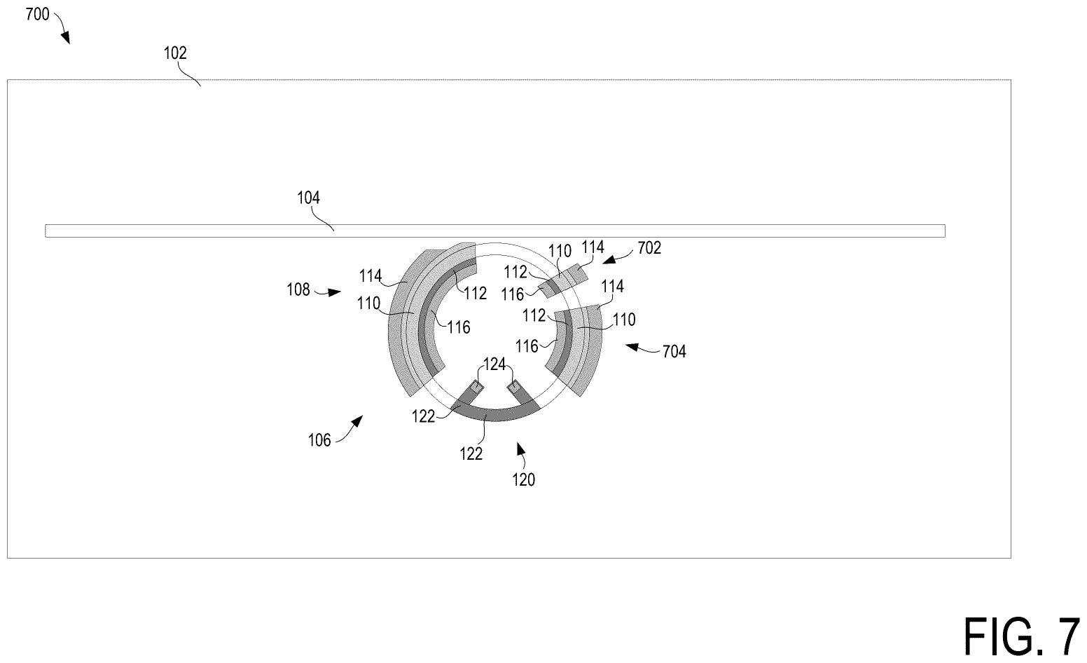

Referring now to FIG. 7, in one embodiment of a PIC die 700, the microring resonator 106 may include a first diode 108, a second diode 702, and a third diode 704. In use, the first diode 108 may be reversed biased, and the second diode 702 and third diode 704 may be forward biased. As discussed above, forward-biased diodes 702, 704 of different lengths have different relative blueshifts. Having two forward-biased diodes 702, 704 allows for independent tuning of the blueshift and the quality factor.

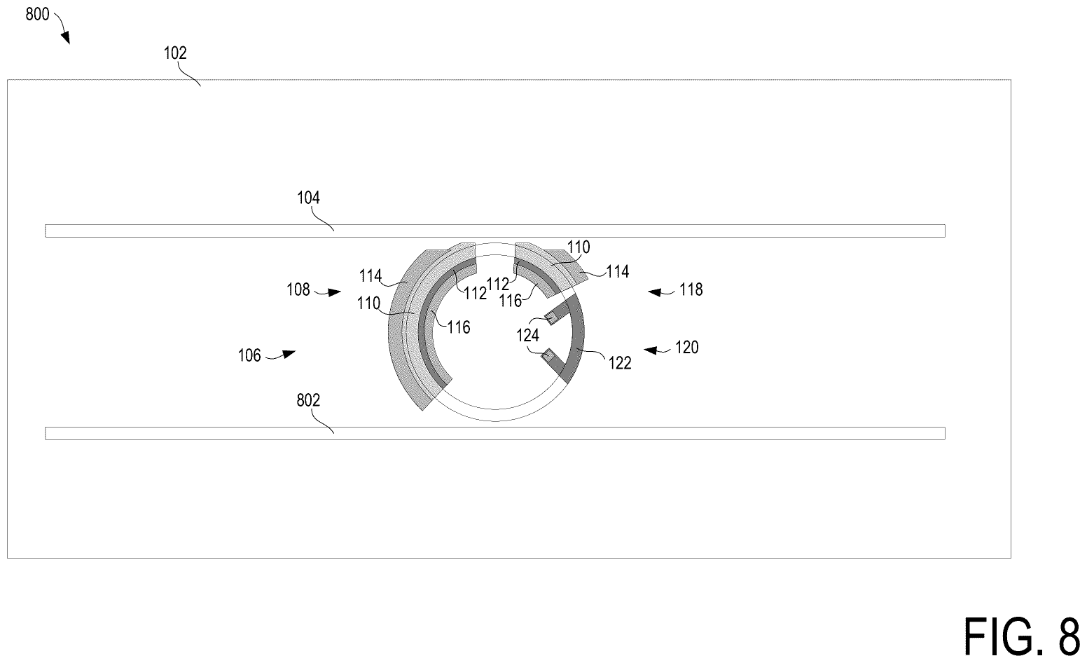

Referring now to FIG. 8, in one embodiment of a PIC die 800, a second waveguide 802 may be coupled to the microring resonator 106. The second waveguide 802 may allow for different functionality for the microring resonator 106. For example, the second waveguide 802 may be used when the microring resonator 106 is being used to add or drop a channel in a multiplexing system.

It should be appreciated that the various features of the embodiments described above may be combined in any suitable manner. For example, a microring resonator 106 may include two diodes 702, 704 that are used in a forward-bias mode as well as an isolation region 502.

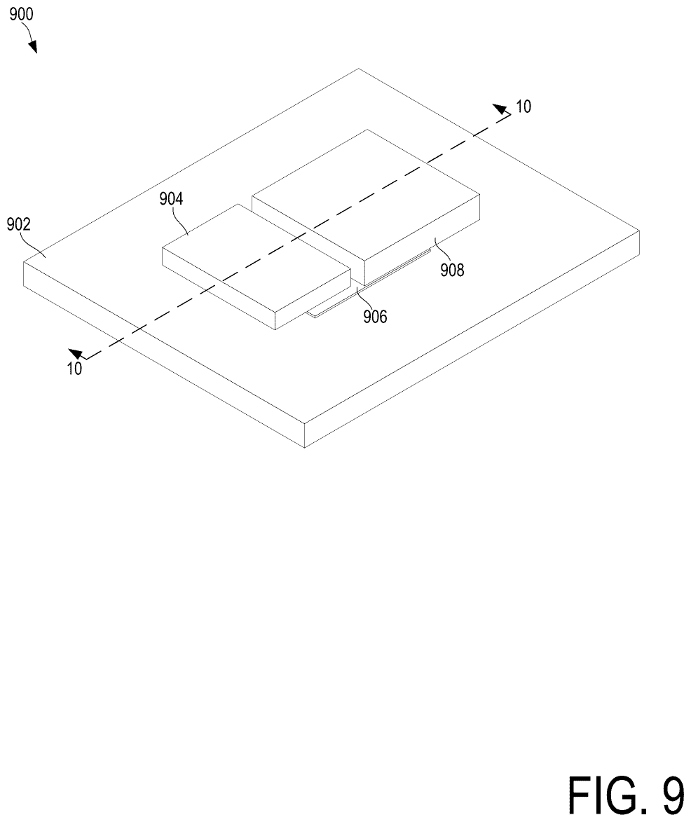

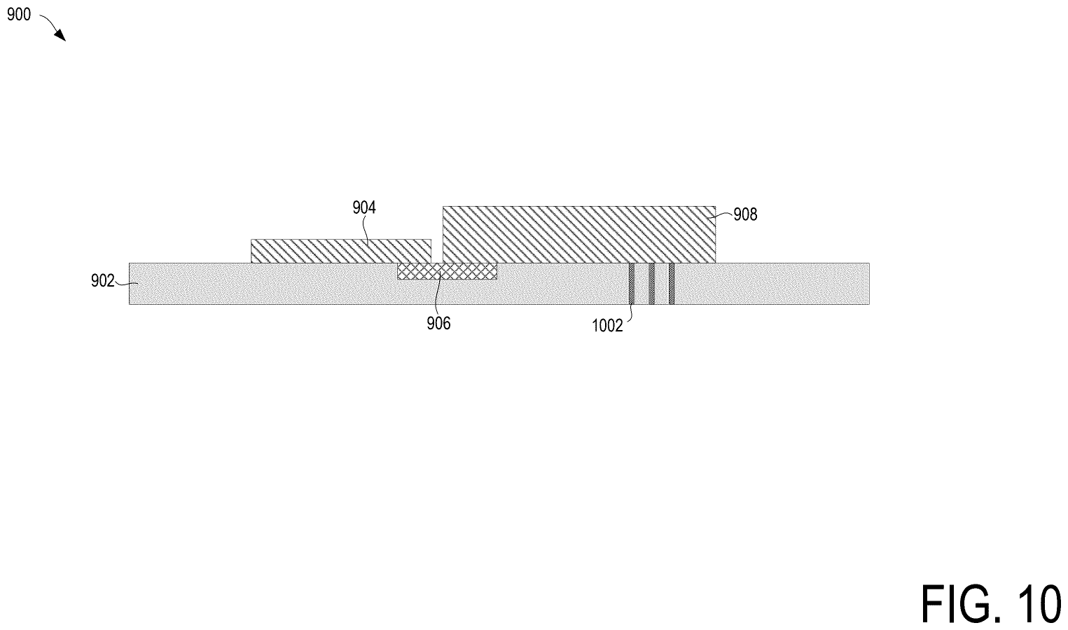

Referring now to FIGS. 9 and 10, in one embodiment, an integrated circuit package 900 includes a substrate 902, a photonic integrated circuit (PIC) die 904, a bridge die 906, and an electronic integrated circuit (EIC) die 908. FIG. 9 shows a perspective view of the integrated circuit package 900, and FIG. 10 shows a cross-sectional view of the integrated circuit package 900. In an illustrative embodiment, the PIC die 904 may be embodied as any of the various PIC dies 100, 400, 500, 600, 700, 800 described above.

The illustrative substrate 902 is glass, such as silicon oxide glass. In other embodiments, the substrate 902 may be made of any suitable material that may be crystalline, non-crystalline, amorphous, etc., such as fused silicon, borosilicate, sapphire, yttrium aluminum garnet, etc. The glass substrate 902 may be, e.g., aluminosilicate glass, borosilicate glass, alumino-borosilicate glass, silica, fused silica. The glass substrate 902 may include one or more additives, such as Al2O3, B2O3, MgO, CaO, SrO, BaO, SnO2, Na2O, K2O, SrO, P2O3, ZrO2, Li2O, Ti, and Zn. The glass substrate 902 may comprise silicon and oxygen, as well as any one or more of aluminum, boron, magnesium, calcium, barium, tin, sodium, potassium, strontium, phosphorus, zirconium, lithium, titanium, and zinc. The glass substrate 902 may include at least 20-40 percent silicon by weight, at least 20-40 percent oxygen by weight, and at least 5 percent aluminum by weight. For example, some embodiments of the glass substrate 902 may include, e.g., at least 20-23 percent silicon and at least 20-26 percent oxygen by weight.

In other embodiments, the substrate 902 may be any suitable material, such as a ceramic substrate or an organic substrate. In some embodiments, the substrate 902 may be embodied as a printed circuit board made from ceramic and/or organic-based materials with fiberglass and resin, such as FR-4. The substrate 902 may have any suitable length or width, such as 10-500 millimeters. The substrate 902 may have any suitable thickness, such as 0.2-5 millimeters. The substrate 902 may support additional components besides those shown in FIGS. 9 and 10, such as one or more build-up layers, additional EIC dies, additional bridge dies, photonic integrated circuit (PIC) dies, waveguides integrated into the substrate 902, additional through-substrate vias, traces, etc. Other components in the integrated circuit package 900 that may be directly or indirectly mounted on or coupled to the substrate 902 include additional photonic or electronic integrated circuit components, a processor unit, a memory device, an accelerator device, etc.

In some embodiments, optical fibers may interface with the substrate 902 and/or the PIC die 904. The system may include any suitable number of optical fibers connected to the integrated circuit package 900, such as 1-1,024.

The PIC die 904 may be made of any suitable material, such as silicon. The PIC die 904 may have waveguides defined within it, such as silicon waveguides embedded in silicon oxide cladding. The PIC die 904 may include any suitable number of waveguides and/or microring resonators, such as 1-1,024. In an illustrative embodiment, the waveguides in the PIC die 904 are edge-coupled waveguides. In other embodiments, the waveguides may be vertically coupled out of the PIC die 904. In some embodiments, the PIC die 904 may be embodied as or include, e.g., indium phosphide, gallium arsenide, lithium niobate, silicon nitride, chalcogenide, and/or the like.

In some embodiments, the PIC die 904 may be configured to generate, detect, and/or manipulate light. The PIC die 904 may include active or passive optical elements such as splitters, couplers, filters, optical amplifiers, lasers, photodetectors, modulators, routers, etc. The PIC die 904 may operate at any suitable wavelength or range of wavelengths, such as 400-2,000 nanometers.

The EIC die 908 may include any suitable electronic integrated circuit component, such as resistors, capacitors, inductors, transistors, etc. The EIC die 908 may include any suitable analog and/or digital circuitry, such as a processor, a memory, an application-specific integrated circuit (ASIC), a field-programmable gate array (FPGA), etc. In an illustrative embodiment, the EIC die 908 may be embodied as an xPU, such as a central processing unit or a graphics processing unit. The EIC die 908 may be embodied as or otherwise include circuitry to drive components on the PIC die 904, such as lasers, modulators, etc., and/or the EIC die 908 may be embodied as or otherwise include circuitry to receive signals from components on the PIC die 904, such as photodetectors. The EIC die 908 may include control circuitry to control the various components of the microring resonators 106 on the PIC die 904, such as the diodes 108, 118, the heater 120, etc. The EIC die 908 may use the PIC die 904 to communicate using optical signals with other dies in the same package 900, other integrated circuit packages, other compute devices, etc. In some embodiments, the integrated circuit package 900 may be embodied as a router, a switch, a network interface controller, and/or the like. In such embodiments, the EIC die 908 may include network interface controller circuitry to process, parse, route, etc., network packets sent and received by the integrated circuit package 900.

In an illustrative embodiment, the EIC die 908 is mounted on the substrate 902. The EIC die 908 may be connected to the substrate 902 through pads and/or solder bumps. The pads and/or solder bumps may be used to transmit and receive signals between the EIC die 908 and the substrate 902, provide power to the EIC die 908, etc. The substrate 902 may provide various electrical connections. For example, the substrate 902 may include a redistribution layer on the bottom of the substrate 902 and/or may include a redistribution layer on the top of the substrate 902, which may be embodied as one or more build-up layers. In some embodiments, one or more vias 1002 may extend through the substrate 902. The vias 1002 may be used to provide power, I/O, letch, etc., to the EIC die 908 and/or other components, such as the bridge die 906, the PIC die 904, etc.

The bridge die 906 provides interconnect circuitry for connections between the EIC die 908 and the PIC die 904. The bridge die 906 may be embodied as, e.g., an embedded multi-die interconnect bridge (EMIB) or an omni-directional interconnect (ODI). The bridge die 906 may carry power signals and/or data signals to, from, or between any suitable combination of the EIC die 908, the PIC die 904, and/or the substrate 902. The bridge die 906 may include any suitable number of power and/or data signal pads connected to the EIC die 908, the PIC die 904, or other component, such as 1-1,024 pads.

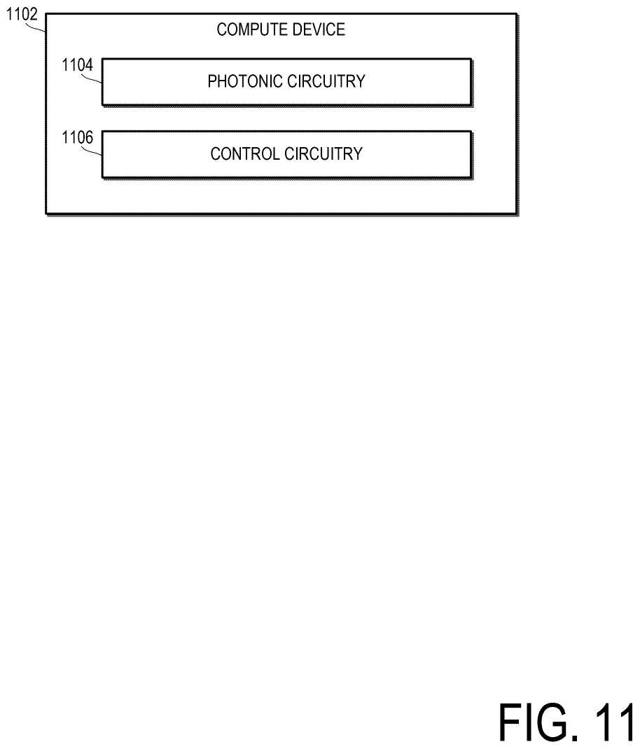

Referring now to FIG. 11, in one embodiment, a compute device 1102 includes a photonic circuitry 1104 and control circuitry 1106. Some of the modules of the compute device 1100, such as the control circuitry 1106, may be embodied as hardware, software, firmware, or a combination thereof. For example, the various modules, logic, and other components of the compute device 1100 may form a portion of, or otherwise be established by, a processor, memory, data storage, or other hardware components of a computing device, such as the electrical device 1800 described below. The compute device 1100 may be embodied as a system-on-a-chip or a system-on-a-package. Such a system or package may include one or more electronic integrated circuit (EIC) dies and/or one or more PIC dies, such as any suitable embodiment of the integrated circuit package 900, EIC dies 908, and/or PIC dies 100, 400, 500, 600, 700, 800, 904 described above. The control circuitry 1106 may be embodied as one or more EIC dies communicatively coupled to and/or packaged with the one or more PIC dies 100 embodying the photonic circuitry 1104.

In some embodiments, one or more of the modules of the system 1100 may be embodied as circuitry or collection of electrical devices. It should be appreciated that, in such embodiments, one or more of the circuits may form a portion of one or more of the processor, the memory, the data storage and/or other components of a computing device. For example, in some embodiments, some or all of the modules may be embodied as or include a processor as well as memory and/or data storage storing instructions to be executed by the processor. Additionally, in some embodiments, one or more of the illustrative modules may form a portion of another module and/or one or more of the illustrative modules may be independent of one another. Further, in some embodiments, one or more of the modules of the compute device 1100 may be embodied as virtualized hardware components or emulated architecture, which may be established and maintained by the processor or other components of a computing device. It should be appreciated that some of the functionality of one or more of the modules of the compute device 1100 may require a hardware implementation, in which case embodiments of modules that implement such functionality will be embodied at least partially as hardware.

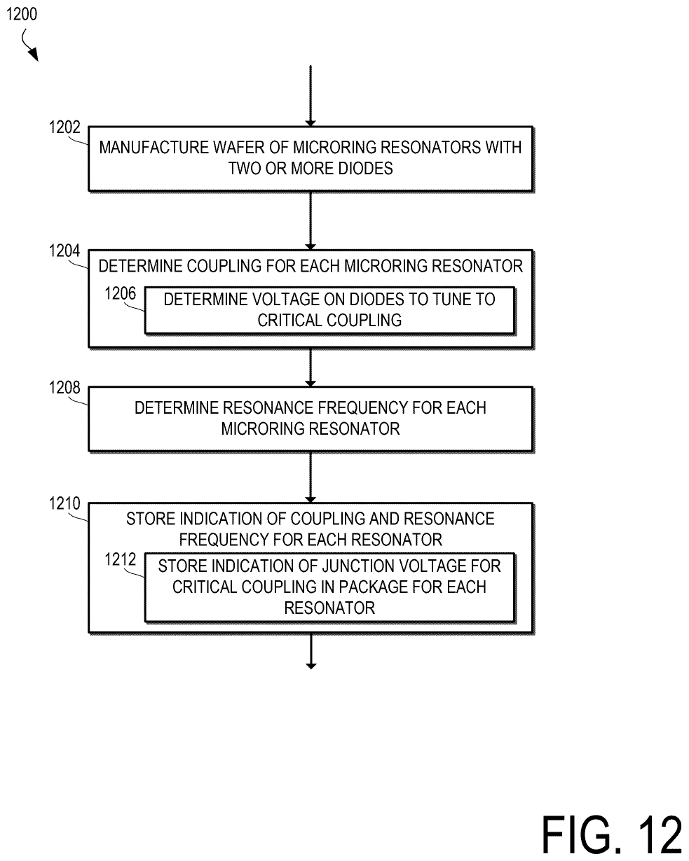

Referring now to FIG. 12, in use, a flowchart for a method 1200 for creating microring resonators 106 is shown. The method 1200 may be executed by a technician and/or by one or more automated machines. In some embodiments, one or more machines may be programmed to do some or all of the steps of the method 1200. Such a machine may include, e.g., a memory, a processor, data storage, etc. The memory and/or data storage may store instructions that, when executed by the machine, cause the machine to perform some or all of the steps of the method 1200. The method 1200 may use any suitable set of techniques that are used in semiconductor processing or circuit board processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, laser machining, 3D photolithography, screen printing, ink jet printing, etc. It should be appreciated that the method 1200 is merely one embodiment of a method to create one embodiment of a system and other methods may be used to create any suitable embodiment of the system. In some embodiments, steps of the method 1200 may be performed in a different order than that shown in the flowchart.

The method 1200 begins in block 1202, in which the a wafer of microring resonators 106 with two or more diodes 108, 118 is manufactured.

In block 1204, a coupling rate for each microring resonator 106 to a waveguide 104 is determined, such as when no voltage is applied to the diodes 108, 118. In block 1206, a forward bias voltage on a diode 118 is determined to tune to a critical coupling regime. The coupling and/or forward bias voltage may be determined before or after the wafer is diced.

In block 1208, a resonance frequency is determined for each microring resonator 106. In an illustrative embodiment, the resonance frequency is determined at an expected operating temperature without any heating due to optical effects.

In block 1210, an indication of the coupling and resonance frequency for each resonator 106 is stored, and, in block 1212, an indication of a junction voltage to reach a critical coupling regime is stored for each resonator 106. The indication of the coupling and resonance frequency and the indication of the junction voltage may be stored in any suitable manner, such as on the PIC die 100 with the resonator 106, on an EIC die 908 on an integrated circuit package 900 that includes the PIC die 904, on data storage associated with the resonator 106, etc.

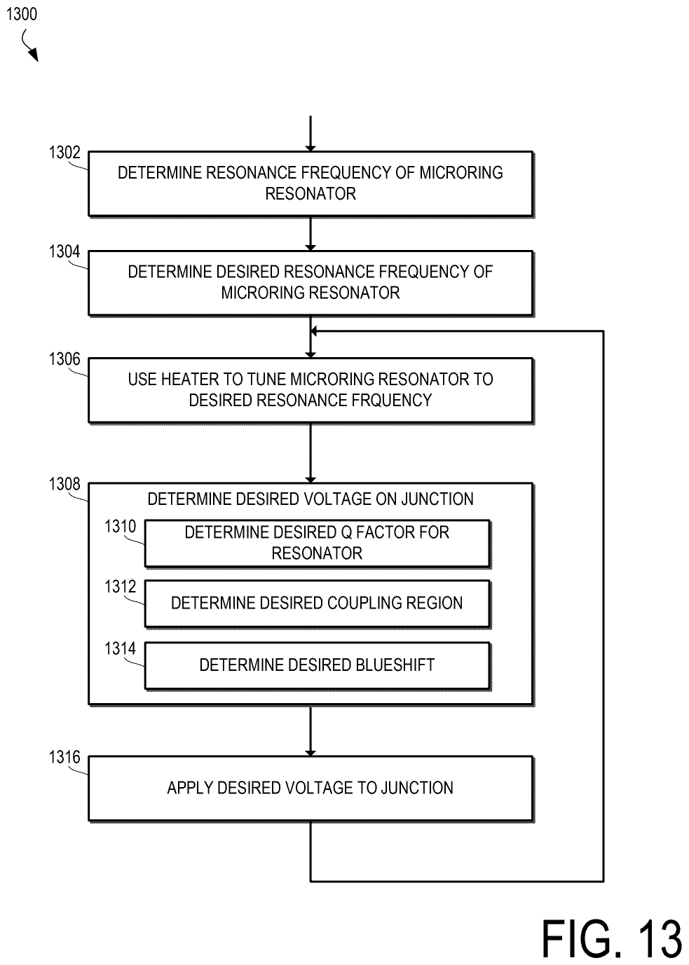

Referring now to FIG. 13, in use, a compute device 1102 may execute a method 1300 for operating microring resonators 106. The method 1300 may be performed by, e.g., control circuitry 1106 of the compute device 1102. The method 1300 begins in block 1302, in which a compute device 1102 determines a resonance frequency of the microring resonator 106. The compute device 1102 may access an indication of a resonance frequency of the microring resonator, such as by accessing a value stored on the compute device 1102. Additionally or alternatively, in some embodiments, the compute device 1102 may determine the resonance frequency, such as by using a heater to sweep the resonance frequency to match a laser frequency, or sweep a laser frequency to match the resonance frequency.

In block 1304, the compute device 1102 determines a desired resonance frequency of the microring resonator 106, such as by determining a wavelength of a laser that will be coupled to the microring resonator 106. In block 1306, the compute device 1102 tunes the resonance frequency of the microring resonator 106 to a desired resonance frequency, such as by using a heater 120.

In block 1308, a compute device 1102 determines a desired voltage on a junction of a diode 118 of a microring resonator 106. The compute device 1102 may access an indication of a coupling rate of a waveguide 104 to a microring resonator 106 when no voltage is applied to the diode 118, such as by accessing a value stored on the compute device 1102. Additionally or alternatively, in some embodiments, the compute device 1102 may calibrate the coupling by, e.g., sweeping a wavelength of a light source across the resonance of the microring resonator 106 and/or by sweeping the resonance of the microring resonator 106 across the wavelength of a light source.

To determine the desired voltage, the compute device 1102 may, e.g., determine a desired quality factor in block 1310, such as a desired quality factor compared to a current quality factor, and determine a corresponding voltage on the diode 118. Additionally or alternatively, the compute device 1102 may determine a desired coupling region in block 1312, such as overcoupled, undercoupled, or critically coupled, or a particular region in an overcoupled or undercoupled regime. For example, the compute device 1102 may determine a desired amount of chirp and may determine a desired overcoupled or undercoupled region based on the desired amount of chirp and then determine a corresponding voltage on the diode 118. In other embodiments, the compute device 1102 may additionally or alternatively determine a desired amount of blueshift in block 1314 and determine a corresponding voltage on the diode 118. The compute device 1102 may determine a desired voltage for the various reasons described above in more detail, such as to compensate for variations in a coupling rate due to process variations, to impart a desired chirp, to get a higher optical bandwidth or a higher modulation speed, to add a blueshift to compensate for redshift resulting from baseline wandering, etc.

In block 1316, the compute device 1102 applies the desired voltage to the diode 118. The method 1300 then loops back to block 1306 to use the heater to tune the microring resonator 106 to a desired resonance frequency. It should be appreciated that, in some embodiments, the heather 120 may be used in a closed-loop configuration to track the resonance frequency of the microring resonator 106.

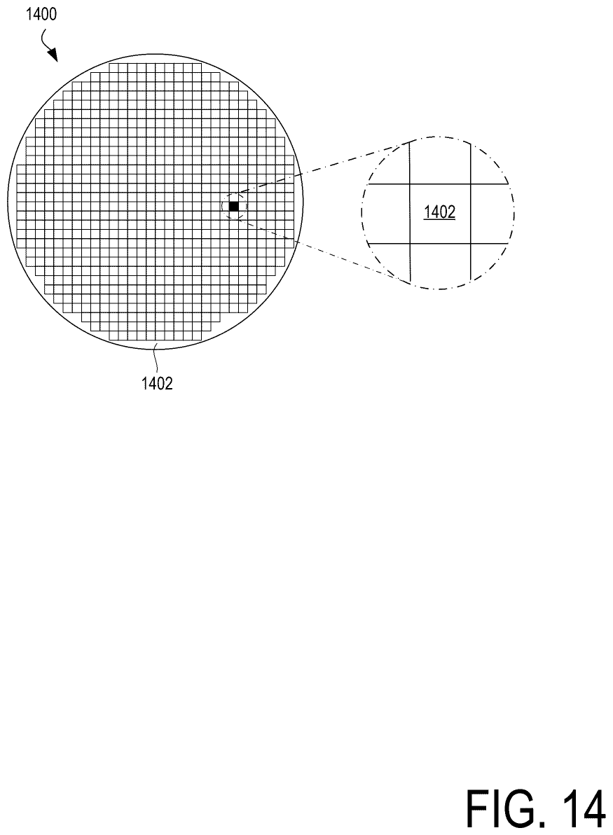

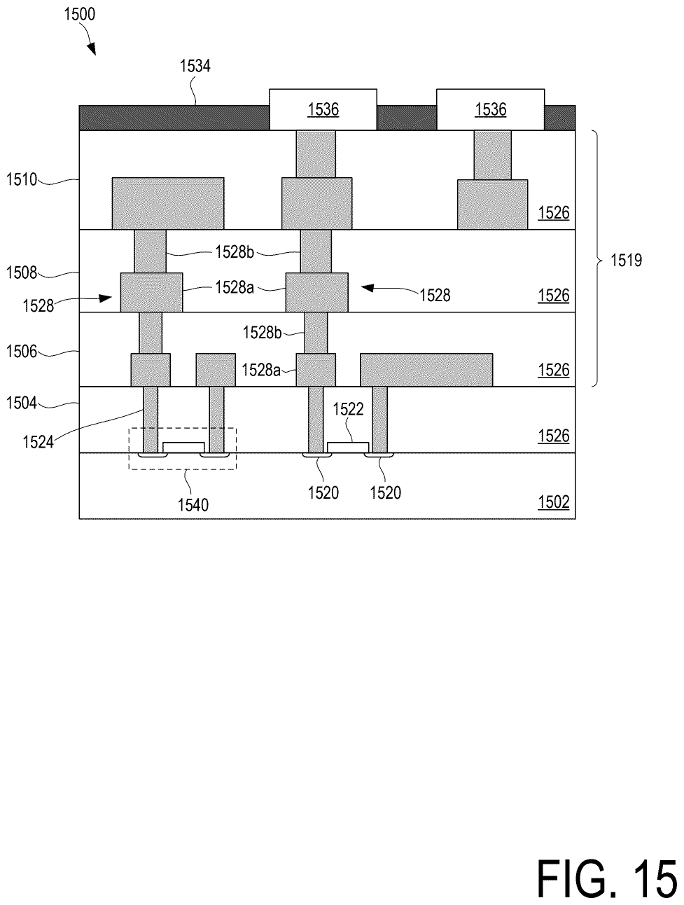

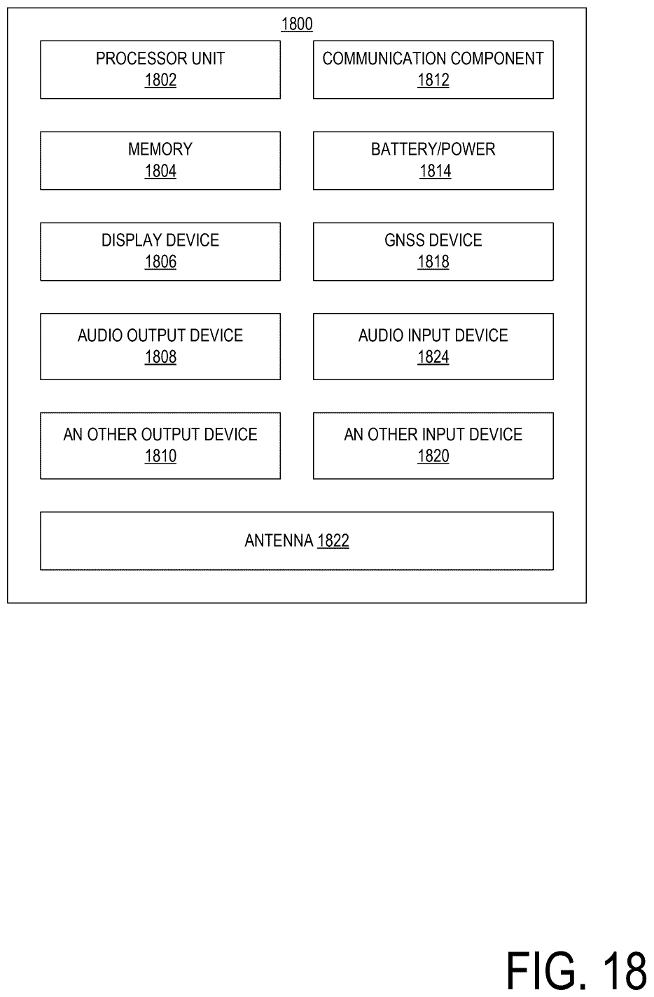

FIG. 14 is a top view of a wafer 1400 and dies 1402 that may be included in any of the integrated circuit packages 900 disclosed herein (e.g., as any suitable ones of the dies 100, 400, 500, 600, 700, 800, 904, 908). The wafer 1400 may be composed of semiconductor material and may include one or more dies 1402 having integrated circuit structures formed on a surface of the wafer 1400. The individual dies 1402 may be a repeating unit of an integrated circuit product that includes any suitable integrated circuit. After the fabrication of the semiconductor product is complete, the wafer 1400 may undergo a singulation process in which the dies 1402 are separated from one another to provide discrete “chips” of the integrated circuit product. The die 1402 may be any of the dies 100, 400, 500, 600, 700, 800, 904, 908 disclosed herein. The die 1402 may include one or more transistors (e.g., some of the transistors 1540 of FIG. 15, discussed below), supporting circuitry to route electrical signals to the transistors, passive components (e.g., signal traces, resistors, capacitors, or inductors), and/or any other integrated circuit components. In some embodiments, the wafer 1400 or the die 1402 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1402. For example, a memory array formed by multiple memory devices may be formed on a same die 1402 as a processor unit (e.g., the processor unit 1802 of FIG. 18) or other logic that is configured to store information in the memory devices or execute instructions stored in the memory array. Various ones of the integrated circuit packages 900 disclosed herein may be manufactured using a die-to-wafer assembly technique in which some dies 100, 400, 500, 600, 700, 800, 904, 908 are attached to a wafer 1400 that include others of the dies 100, 400, 500, 600, 700, 800, 904, 908, and the wafer 1400 is subsequently singulated.

FIG. 15 is a cross-sectional side view of an integrated circuit device 1500 that may be included in any of the integrated circuit packages 900 disclosed herein (e.g., in any of the dies 100, 400, 500, 600, 700, 800, 904, 908). One or more of the integrated circuit devices 1500 may be included in one or more dies 1402 (FIG. 14). The integrated circuit device 1500 may be formed on a die substrate 1502 (e.g., the wafer 1400 of FIG. 14) and may be included in a die (e.g., the die 1402 of FIG. 14). The die substrate 1502 may be a semiconductor substrate composed of semiconductor material systems including, for example, n-type or p-type materials systems (or a combination of both). The die substrate 1502 may include, for example, a crystalline substrate formed using a bulk silicon or a silicon-on-insulator (SOI) substructure. In some embodiments, the die substrate 1502 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1502. Although a few examples of materials from which the die substrate 1502 may be formed are described here, any material that may serve as a foundation for an integrated circuit device 1500 may be used. The die substrate 1502 may be part of a singulated die (e.g., the dies 1402 of FIG. 14) or a wafer (e.g., the wafer 1400 of FIG. 14).

The integrated circuit device 1500 may include one or more device layers 1504 disposed on the die substrate 1502. The device layer 1504 may include features of one or more transistors 1540 (e.g., metal oxide semiconductor field-effect transistors (MOSFETs)) formed on the die substrate 1502. The transistors 1540 may include, for example, one or more source and/or drain (S/D) regions 1520, a gate 1522 to control current flow between the S/D regions 1520, and one or more S/D contacts 1524 to route electrical signals to/from the S/D regions 1520. The transistors 1540 may include additional features not depicted for the sake of clarity, such as device isolation regions, gate contacts, and the like. The transistors 1540 are not limited to the type and configuration depicted in FIG. 15 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

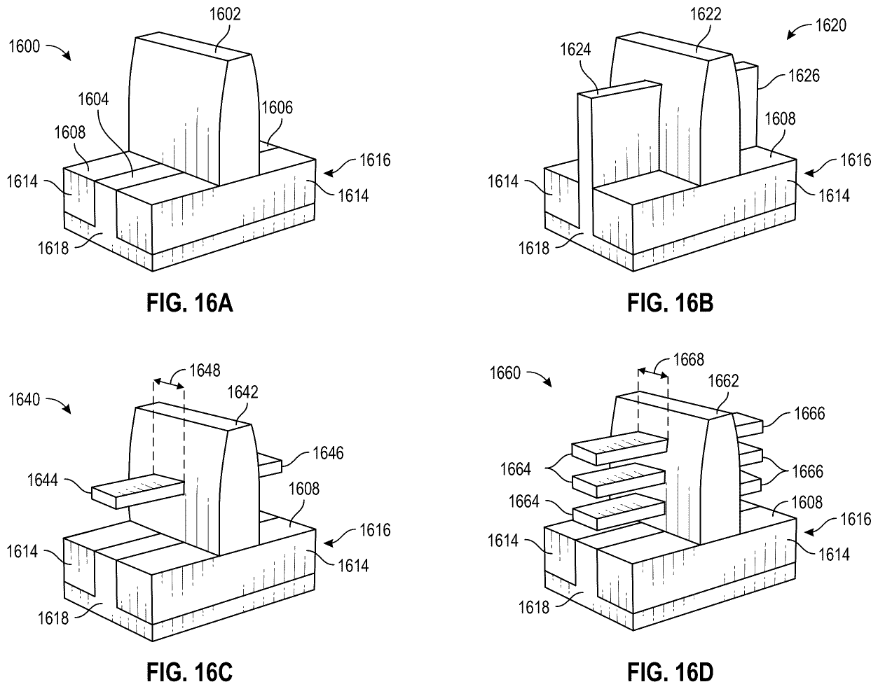

FIGS. 16A-16D are simplified perspective views of example planar, FinFET, gate-all-around, and stacked gate-all-around transistors. The transistors illustrated in FIGS. 16A-16D are formed on a substrate 1616 having a surface 1608. Isolation regions 1614 separate the source and drain regions of the transistors from other transistors and from a bulk region 1618 of the substrate 1616.

FIG. 16A is a perspective view of an example planar transistor 1600 comprising a gate 1602 that controls current flow between a source region 1604 and a drain region 1606. The transistor 1600 is planar in that the source region 1604 and the drain region 1606 are planar with respect to the substrate surface 1608.

FIG. 16B is a perspective view of an example FinFET transistor 1620 comprising a gate 1622 that controls current flow between a source region 1624 and a drain region 1626. The transistor 1620 is non-planar in that the source region 1624 and the drain region 1626 comprise “fins” that extend upwards from the substrate surface 1628. As the gate 1622 encompasses three sides of the semiconductor fin that extends from the source region 1624 to the drain region 1626, the transistor 1620 can be considered a tri-gate transistor. FIG. 16B illustrates one S/D fin extending through the gate 1622, but multiple S/D fins can extend through the gate of a FinFET transistor.

FIG. 16C is a perspective view of a gate-all-around (GAA) transistor 1640 comprising a gate 1642 that controls current flow between a source region 1644 and a drain region 1646. The transistor 1640 is non-planar in that the source region 1644 and the drain region 1646 are elevated from the substrate surface 1628.

FIG. 16D is a perspective view of a GAA transistor 1660 comprising a gate 1662 that controls current flow between multiple elevated source regions 1664 and multiple elevated drain regions 1666. The transistor 1660 is a stacked GAA transistor as the gate controls the flow of current between multiple elevated S/D regions stacked on top of each other. The transistors 1640 and 1660 are considered gate-all-around transistors as the gates encompass all sides of the semiconductor portions that extends from the source regions to the drain regions. The transistors 1640 and 1660 can alternatively be referred to as nanowire, nanosheet, or nanoribbon transistors depending on the width (e.g., widths 1648 and 1668 of transistors 1640 and 1660, respectively) of the semiconductor portions extending through the gate.

Returning to FIG. 15, a transistor 1540 may include a gate 1522 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1540 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1540 along the source-channel-drain direction, the gate electrode may consist of a U-shaped structure that includes a bottom portion substantially parallel to the surface of the die substrate 1502 and two sidewall portions that are substantially perpendicular to the top surface of the die substrate 1502. In other embodiments, at least one of the metal layers that form the gate electrode may simply be a planar layer that is substantially parallel to the top surface of the die substrate 1502 and does not include sidewall portions substantially perpendicular to the top surface of the die substrate 1502. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1520 may be formed within the die substrate 1502 adjacent to the gate 1522 of individual transistors 1540. The S/D regions 1520 may be formed using an implantation/diffusion process or an etching/deposition process, for example. In the former process, dopants such as boron, aluminum, antimony, phosphorous, or arsenic may be ion-implanted into the die substrate 1502 to form the S/D regions 1520. An annealing process that activates the dopants and causes them to diffuse farther into the die substrate 1502 may follow the ion-implantation process. In the latter process, the die substrate 1502 may first be etched to form recesses at the locations of the S/D regions 1520. An epitaxial deposition process may then be carried out to fill the recesses with material that is used to fabricate the S/D regions 1520. In some implementations, the S/D regions 1520 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1520 may be formed using one or more alternate semiconductor materials such as germanium or a group III-V material or alloy. In further embodiments, one or more layers of metal and/or metal alloys may be used to form the S/D regions 1520.

Electrical signals, such as power and/or input/output (I/O) signals, may be routed to and/or from the devices (e.g., transistors 1540) of the device layer 1504 through one or more interconnect layers disposed on the device layer 1504 (illustrated in FIG. 15 as interconnect layers 1506-1510). For example, electrically conductive features of the device layer 1504 (e.g., the gate 1522 and the S/D contacts 1524) may be electrically coupled with the interconnect structures 1528 of the interconnect layers 1506-1510. The one or more interconnect layers 1506-1510 may form a metallization stack (also referred to as an “ILD stack”) 1519 of the integrated circuit device 1500.

The interconnect structures 1528 may be arranged within the interconnect layers 1506-1510 to route electrical signals according to a wide variety of designs; in particular, the arrangement is not limited to the particular configuration of interconnect structures 1528 depicted in FIG. 15. Although a particular number of interconnect layers 1506-1510 is depicted in FIG. 15, embodiments of the present disclosure include integrated circuit devices having more or fewer interconnect layers than depicted.

In some embodiments, the interconnect structures 1528 may include lines 1528a and/or vias 1528b filled with an electrically conductive material such as a metal. The lines 1528a may be arranged to route electrical signals in a direction of a plane that is substantially parallel with a surface of the die substrate 1502 upon which the device layer 1504 is formed. For example, the lines 1528a may route electrical signals in a direction in and out of the page and/or in a direction across the page. The vias 1528b may be arranged to route electrical signals in a direction of a plane that is substantially perpendicular to the surface of the die substrate 1502 upon which the device layer 1504 is formed. In some embodiments, the vias 1528b may electrically couple lines 1528a of different interconnect layers 1506-1510 together.

The interconnect layers 1506-1510 may include a dielectric material 1526 disposed between the interconnect structures 1528, as shown in FIG. 15. In some embodiments, dielectric material 1526 disposed between the interconnect structures 1528 in different ones of the interconnect layers 1506-1510 may have different compositions; in other embodiments, the composition of the dielectric material 1526 between different interconnect layers 1506-1510 may be the same. The device layer 1504 may include a dielectric material 1526 disposed between the transistors 1540 and a bottom layer of the metallization stack as well. The dielectric material 1526 included in the device layer 1504 may have a different composition than the dielectric material 1526 included in the interconnect layers 1506-1510; in other embodiments, the composition of the dielectric material 1526 in the device layer 1504 may be the same as a dielectric material 1526 included in any one of the interconnect layers 1506-1510.

A first interconnect layer 1506 (referred to as Metal 1 or “M1”) may be formed directly on the device layer 1504. In some embodiments, the first interconnect layer 1506 may include lines 1528a and/or vias 1528b, as shown. The lines 1528a of the first interconnect layer 1506 may be coupled with contacts (e.g., the S/D contacts 1524) of the device layer 1504. The vias 1528b of the first interconnect layer 1506 may be coupled with the lines 1528a of a second interconnect layer 1508.

The second interconnect layer 1508 (referred to as Metal 2 or “M2”) may be formed directly on the first interconnect layer 1506. In some embodiments, the second interconnect layer 1508 may include via 1528b to couple the lines 1528 of the second interconnect layer 1508 with the lines 1528a of a third interconnect layer 1510. Although the lines 1528a and the vias 1528b are structurally delineated with a line within individual interconnect layers for the sake of clarity, the lines 1528a and the vias 1528b may be structurally and/or materially contiguous (e.g., simultaneously filled during a dual-damascene process) in some embodiments.

The third interconnect layer 1510 (referred to as Metal 3 or “M3”) (and additional interconnect layers, as desired) may be formed in succession on the second interconnect layer 1508 according to similar techniques and configurations described in connection with the second interconnect layer 1508 or the first interconnect layer 1506. In some embodiments, the interconnect layers that are “higher up” in the metallization stack 1519 in the integrated circuit device 1500 (i.e., farther away from the device layer 1504) may be thicker that the interconnect layers that are lower in the metallization stack 1519, with lines 1528a and vias 1528b in the higher interconnect layers being thicker than those in the lower interconnect layers.

The integrated circuit device 1500 may include a solder resist material 1534 (e.g., polyimide or similar material) and one or more conductive contacts 1536 formed on the interconnect layers 1506-1510. In FIG. 15, the conductive contacts 1536 are illustrated as taking the form of bond pads. The conductive contacts 1536 may be electrically coupled with the interconnect structures 1528 and configured to route the electrical signals of the transistor(s) 1540 to external devices. For example, solder bonds may be formed on the one or more conductive contacts 1536 to mechanically and/or electrically couple an integrated circuit die including the integrated circuit device 1500 with another component (e.g., a printed circuit board). The integrated circuit device 1500 may include additional or alternate structures to route the electrical signals from the interconnect layers 1506-1510; for example, the conductive contacts 1536 may include other analogous features (e.g., posts) that route the electrical signals to external components.

In some embodiments in which the integrated circuit device 1500 is a double-sided die, the integrated circuit device 1500 may include another metallization stack (not shown) on the opposite side of the device layer(s) 1504. This metallization stack may include multiple interconnect layers as discussed above with reference to the interconnect layers 1506-1510, to provide conductive pathways (e.g., including conductive lines and vias) between the device layer(s) 1504 and additional conductive contacts (not shown) on the opposite side of the integrated circuit device 1500 from the conductive contacts 1536.

In other embodiments in which the integrated circuit device 1500 is a double-sided die, the integrated circuit device 1500 may include one or more through silicon vias (TSVs) through the die substrate 1502; these TSVs may make contact with the device layer(s) 1504, and may provide conductive pathways between the device layer(s) 1504 and additional conductive contacts (not shown) on the opposite side of the integrated circuit device 1500 from the conductive contacts 1536. In some embodiments, TSVs extending through the substrate can be used for routing power and ground signals from conductive contacts on the opposite side of the integrated circuit device 1500 from the conductive contacts 1536 to the transistors 1540 and any other components integrated into the die 1500, and the metallization stack 1519 can be used to route I/O signals from the conductive contacts 1536 to transistors 1540 and any other components integrated into the die 1500.

Multiple integrated circuit devices 1500 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

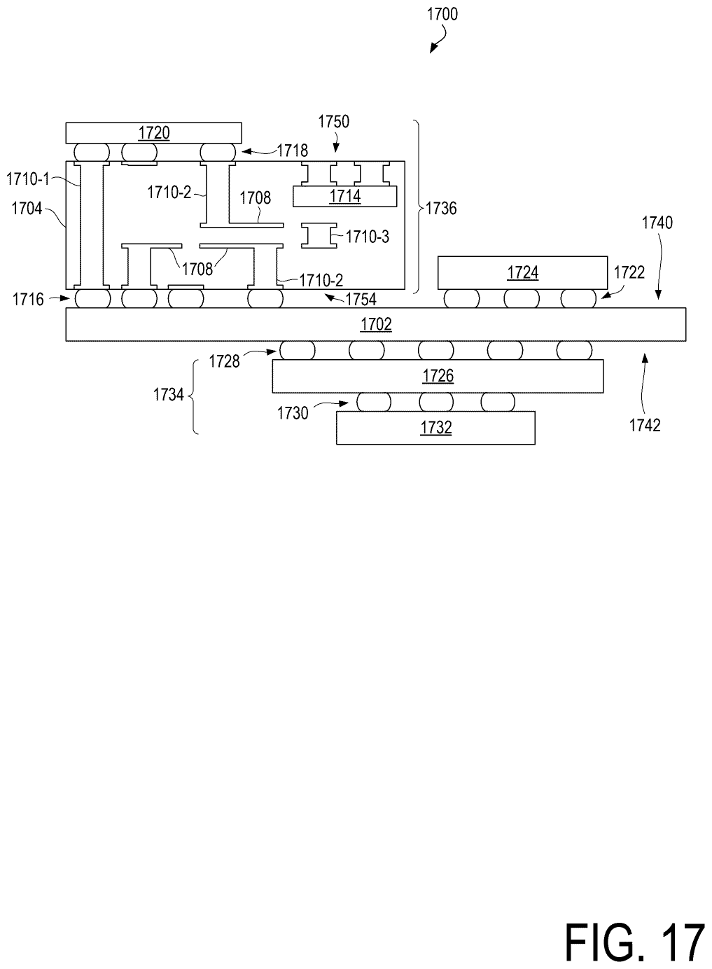

FIG. 17 is a cross-sectional side view of an integrated circuit device assembly 1700 that may include any of the integrated circuit packages 900 disclosed herein. In some embodiments, the integrated circuit device assembly 1700 may be an integrated circuit package 900. The integrated circuit device assembly 1700 includes a number of components disposed on a circuit board 1702 (which may be a motherboard, system board, mainboard, etc.). The integrated circuit device assembly 1700 includes components disposed on a first face 1740 of the circuit board 1702 and an opposing second face 1742 of the circuit board 1702; generally, components may be disposed on one or both faces 1740 and 1742. Any of the integrated circuit components discussed below with reference to the integrated circuit device assembly 1700 may take the form of any suitable ones of the embodiments of the integrated circuit packages 900 disclosed herein.

In some embodiments, the circuit board 1702 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1702. In other embodiments, the circuit board 1702 may be a non-PCB substrate. In some embodiments the circuit board 1702 may be, for example, the circuit board 902. The integrated circuit device assembly 1700 illustrated in FIG. 17 includes a package-on-interposer structure 1736 coupled to the first face 1740 of the circuit board 1702 by coupling components 1716. The coupling components 1716 may electrically and mechanically couple the package-on-interposer structure 1736 to the circuit board 1702, and may include solder balls (as shown in FIG. 17), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1716 may serve as the coupling components illustrated or described for any of the substrate assembly or substrate assembly components described herein, as appropriate.

The package-on-interposer structure 1736 may include an integrated circuit component 1720 coupled to an interposer 1704 by coupling components 1718. The coupling components 1718 may take any suitable form for the application, such as the forms discussed above with reference to the coupling components 1716. Although a single integrated circuit component 1720 is shown in FIG. 17, multiple integrated circuit components may be coupled to the interposer 1704; indeed, additional interposers may be coupled to the interposer 1704. The interposer 1704 may provide an intervening substrate used to bridge the circuit board 1702 and the integrated circuit component 1720.

The integrated circuit component 1720 may be a packaged or unpacked integrated circuit product that includes one or more integrated circuit dies (e.g., the die 1402 of FIG. 14, the integrated circuit device 1500 of FIG. 15) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1720, a single monolithic integrated circuit die comprises solder bumps attached to contacts on the die. The solder bumps allow the die to be directly attached to the interposer 1704. The integrated circuit component 1720 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1720 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1720 comprises multiple integrated circuit dies, the dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1720 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1704 may spread connections to a wider pitch or reroute a connection to a different connection. For example, the interposer 1704 may couple the integrated circuit component 1720 to a set of ball grid array (BGA) conductive contacts of the coupling components 1716 for coupling to the circuit board 1702. In the embodiment illustrated in FIG. 17, the integrated circuit component 1720 and the circuit board 1702 are attached to opposing sides of the interposer 1704; in other embodiments, the integrated circuit component 1720 and the circuit board 1702 may be attached to a same side of the interposer 1704. In some embodiments, three or more components may be interconnected by way of the interposer 1704.

In some embodiments, the interposer 1704 may be formed as a PCB, including multiple metal layers separated from one another by layers of dielectric material and interconnected by electrically conductive vias. In some embodiments, the interposer 1704 may be formed of an epoxy resin, a fiberglass-reinforced epoxy resin, an epoxy resin with inorganic fillers, a ceramic material, or a polymer material such as polyimide. In some embodiments, the interposer 1704 may be formed of alternate rigid or flexible materials that may include the same materials described above for use in a semiconductor substrate, such as silicon, germanium, and other group III-V and group IV materials. The interposer 1704 may include metal interconnects 1708 and vias 1710, including but not limited to through hole vias 1710-1 (that extend from a first face 1750 of the interposer 1704 to a second face 1754 of the interposer 1704), blind vias 1710-2 (that extend from the first or second faces 1750 or 1754 of the interposer 1704 to an internal metal layer), and buried vias 1710-3 (that connect internal metal layers).

In some embodiments, the interposer 1704 can comprise a silicon interposer. Through silicon vias (TSV) extending through the silicon interposer can connect connections on a first face of a silicon interposer to an opposing second face of the silicon interposer. In some embodiments, an interposer 1704 comprising a silicon interposer can further comprise one or more routing layers to route connections on a first face of the interposer 1704 to an opposing second face of the interposer 1704.

The interposer 1704 may further include embedded devices 1714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1704. The package-on-interposer structure 1736 may take the form of any of the package-on-interposer structures known in the art.

The integrated circuit device assembly 1700 may include an integrated circuit component 1724 coupled to the first face 1740 of the circuit board 1702 by coupling components 1722. The coupling components 1722 may take the form of any of the embodiments discussed above with reference to the coupling components 1716, and the integrated circuit component 1724 may take the form of any of the embodiments discussed above with reference to the integrated circuit component 1720.

The integrated circuit device assembly 1700 illustrated in FIG. 17 includes a package-on-package structure 1734 coupled to the second face 1742 of the circuit board 1702 by coupling components 1728. The package-on-package structure 1734 may include an integrated circuit component 1726 and an integrated circuit component 1732 coupled together by coupling components 1730 such that the integrated circuit component 1726 is disposed between the circuit board 1702 and the integrated circuit component 1732. The coupling components 1728 and 1730 may take the form of any of the embodiments of the coupling components 1716 discussed above, and the integrated circuit components 1726 and 1732 may take the form of any of the embodiments of the integrated circuit component 1720 discussed above. The package-on-package structure 1734 may be configured in accordance with any of the package-on-package structures known in the art.

FIG. 18 is a block diagram of an example electrical device 1800 that may include one or more of the integrated circuit packages 900 disclosed herein. For example, any suitable ones of the components of the electrical device 1800 may include one or more of the integrated circuit device assemblies 1700, integrated circuit components 1720, integrated circuit devices 1500, or integrated circuit dies 1402 disclosed herein, and may be arranged in any of the integrated circuit packages 900 disclosed herein. A number of components are illustrated in FIG. 18 as included in the electrical device 1800, but any one or more of these components may be omitted or duplicated, as suitable for the application. In some embodiments, some or all of the components included in the electrical device 1800 may be attached to one or more motherboards mainboards, or system boards. In some embodiments, one or more of these components are fabricated onto a single system-on-a-chip (SoC) die.

Additionally, in various embodiments, the electrical device 1800 may not include one or more of the components illustrated in FIG. 18, but the electrical device 1800 may include interface circuitry for coupling to the one or more components. For example, the electrical device 1800 may not include a display device 1806, but may include display device interface circuitry (e.g., a connector and driver circuitry) to which a display device 1806 may be coupled. In another set of examples, the electrical device 1800 may not include an audio input device 1824 or an audio output device 1808, but may include audio input or output device interface circuitry (e.g., connectors and supporting circuitry) to which an audio input device 1824 or audio output device 1808 may be coupled.

The electrical device 1800 may include one or more processor units 1802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1800 may include a memory 1804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1804 may include memory that is located on the same integrated circuit die as the processor unit 1802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1800 can comprise one or more processor units 1802 that are heterogeneous or asymmetric to another processor unit 1802 in the electrical device 1800. There can be a variety of differences between the processing units 1802 in a system in terms of a spectrum of metrics of merit including architectural, microarchitectural, thermal, power consumption characteristics, and the like. These differences can effectively manifest themselves as asymmetry and heterogeneity among the processor units 1802 in the electrical device 1800.

In some embodiments, the electrical device 1800 may include a communication component 1812 (e.g., one or more communication components). For example, the communication component 1812 can manage wireless communications for the transfer of data to and from the electrical device 1800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1812 may operate in accordance with other wireless protocols in other embodiments. The electrical device 1800 may include an antenna 1822 to facilitate wireless communications and/or to receive other wireless communications (such as AM or FM radio transmissions).

In some embodiments, the communication component 1812 may manage wired communications, such as electrical, optical, or any other suitable communication protocols (e.g., IEEE 802.3 Ethernet standards). As noted above, the communication component 1812 may include multiple communication components. For instance, a first communication component 1812 may be dedicated to shorter-range wireless communications such as Wi-Fi or Bluetooth, and a second communication component 1812 may be dedicated to longer-range wireless communications such as global positioning system (GPS), EDGE, GPRS, CDMA, WiMAX, LTE, EV-DO, or others. In some embodiments, a first communication component 1812 may be dedicated to wireless communications, and a second communication component 1812 may be dedicated to wired communications.

The electrical device 1800 may include battery/power circuitry 1814. The battery/power circuitry 1814 may include one or more energy storage devices (e.g., batteries or capacitors) and/or circuitry for coupling components of the electrical device 1800 to an energy source separate from the electrical device 1800 (e.g., AC line power).

The electrical device 1800 may include a display device 1806 (or corresponding interface circuitry, as discussed above). The display device 1806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1800 may include an audio output device 1808 (or corresponding interface circuitry, as discussed above). The audio output device 1808 may include any embedded or wired or wirelessly connected external device that generates an audible indicator, such as speakers, headsets, or earbuds.

The electrical device 1800 may include an audio input device 1824 (or corresponding interface circuitry, as discussed above). The audio input device 1824 may include any embedded or wired or wirelessly connected device that generates a signal representative of a sound, such as microphones, microphone arrays, or digital instruments (e.g., instruments having a musical instrument digital interface (MIDI) output). The electrical device 1800 may include a Global Navigation Satellite System (GNSS) device 1818 (or corresponding interface circuitry, as discussed above), such as a Global Positioning System (GPS) device. The GNSS device 1818 may be in communication with a satellite-based system and may determine a geolocation of the electrical device 1800 based on information received from one or more GNSS satellites, as known in the art.

The electrical device 1800 may include an other output device 1810 (or corresponding interface circuitry, as discussed above). Examples of the other output device 1810 may include an audio codec, a video codec, a printer, a wired or wireless transmitter for providing information to other devices, or an additional storage device.

The electrical device 1800 may include an other input device 1820 (or corresponding interface circuitry, as discussed above). Examples of the other input device 1820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1800 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1800 may be any other electronic device that processes data. In some embodiments, the electrical device 1800 may comprise multiple discrete physical components. Given the range of devices that the electrical device 1800 can be manifested as in various embodiments, in some embodiments, the electrical device 1800 can be referred to as a computing device or a computing system.

### EXAMPLES

Illustrative examples of the technologies disclosed herein are provided below. An embodiment of the technologies may include any one or more, and any combination of, the examples described below.
Example 1 includes an apparatus comprising a photonic integrated circuit (PIC) die comprising a waveguide; a microresonator coupled to the waveguide; a first semiconductor junction that at least partially overlaps with the microresonator; and a second semiconductor junction that at least partially overlaps with the microresonator.
Example 2 includes the subject matter of Example 1, and further including control circuitry to control a voltage across the first semiconductor junction to control a resonance frequency of the microresonator; and control a voltage across the second semiconductor junction to control a quality factor of the microresonator.
Example 3 includes the subject matter of any of Examples 1 and 2, and further including control circuitry to reverse bias the first semiconductor junction; and forward bias the second semiconductor junction.
Example 4 includes the subject matter of any of Examples 1-3, and further including control circuitry to determine a desired coupling regime between the waveguide and the microresonator; and control a voltage across the second semiconductor junction at least partially based on the desired coupling regime.
Example 5 includes the subject matter of any of Examples 1-4, and wherein to determine a desired coupling regime between the waveguide and the microresonator comprises to determine that a critical coupling regime between the waveguide and the microresonator is desired, wherein to control the voltage across the second semiconductor junction comprises to control the voltage across the second semiconductor junction to control a coupling regime between the waveguide and the microresonator to be at about critical coupling.
Example 6 includes the subject matter of any of Examples 1-5, and further including control circuitry to determine a desired chirp on light in the waveguide; and control a voltage across the second semiconductor junction at least partially based on the desired chirp on light in the waveguide.
Example 7 includes the subject matter of any of Examples 1-6, and further including control circuitry to determine a desired tradeoff between optical bandwidth of the microresonator and a modulation speed of the microresonator; and control a voltage across the second semiconductor junction at least partially based on the desired tradeoff between optical bandwidth of the microresonator and a modulation speed of the microresonator.
Example 8 includes the subject matter of any of Examples 1-7, and wherein the PIC die further comprises a second waveguide; a second microresonator coupled to the second waveguide; a third semiconductor junction that at least partially overlaps with the second microresonator; a fourth semiconductor junction that at least partially overlaps with the second microresonator; and control circuitry to control a voltage across the second semiconductor junction and a voltage across the fourth semiconductor junction to match a first coupling regime between the waveguide and the microresonator and a second coupling regime between the second waveguide and the second microresonator.
Example 9 includes the subject matter of any of Examples 1-8, and further including control circuitry to determine an amount of a redshift of a resonance the microresonator due to baseline wandering; and control a voltage across the second semiconductor junction to impart a blueshift on the resonance of the microresonator to at least partially offset the redshift of the resonance of the microresonator due to baseline wandering.
Example 10 includes the subject matter of any of Examples 1-9, and wherein the waveguide is a first material, wherein the microresonator is a second material different from the first material.
Example 11 includes the subject matter of any of Examples 1-10, and wherein the first material comprises silicon and nitrogen, wherein the second material comprises gallium and arsenic.
Example 12 includes the subject matter of any of Examples 1-11, and wherein the waveguide comprises silicon and nitrogen.
Example 13 includes the subject matter of any of Examples 1-12, and wherein the microresonator comprises gallium and arsenic.
Example 14 includes the subject matter of any of Examples 1-13, and wherein the microresonator comprises indium and phosphorous.
Example 15 includes the subject matter of any of Examples 1-14, and wherein the first semiconductor junction is a P-N junction, wherein the second semiconductor junction is a P-I-N junction.
Example 16 includes the subject matter of any of Examples 1-15, and further including a third semiconductor junction that at least partially overlaps with the microresonator.
Example 17 includes the subject matter of any of Examples 1-16, and further including control circuitry to control a reverse bias of the first semiconductor junction to modulate a resonance frequency of the microresonator; control a forward bias of the second semiconductor junction to control a quality factor of the microresonator; and control a forward bias of the third semiconductor junction to control an amount of blueshift of a resonance of the microresonator.
Example 18 includes the subject matter of any of Examples 1-17, and wherein the microresonator comprises an isolation region between the first semiconductor junction and the second semiconductor junction.
Example 19 includes the subject matter of any of Examples 1-18, and wherein the isolation region comprises a plurality of alternating p-doped and n-doped regions.
Example 20 includes the subject matter of any of Examples 1-19, and wherein the microresonator comprises an outer edge and an inner edge, wherein the first semiconductor junction comprises a p-doped region at least partially along the outer edge and an n-doped region at least partially along the inner edge, wherein the second semiconductor junction comprises an n-doped region at least partially along the outer edge and a p-doped region at least partially along the inner edge.
Example 21 includes the subject matter of any of Examples 1-20, and further including a second waveguide, wherein the second waveguide is coupled to the microresonator.
Example 22 includes the subject matter of any of Examples 1-21, and wherein the microresonator is a microring resonator.
Example 23 includes the subject matter of any of Examples 1-22, and wherein the microresonator is a racetrack resonator.
Example 24 includes the subject matter of any of Examples 1-23, and further including a heater thermally coupled to the microresonator.
Example 25 includes the subject matter of any of Examples 1-24, and further including an integrated circuit package, wherein the integrated circuit package comprises the PIC die, a substrate, and an electronic integrated circuit (EIC) die.
Example 26 includes an apparatus comprising a photonic integrated circuit (PIC) die comprising a waveguide; a microresonator coupled to the waveguide; and a variable optical attenuator that at least partially overlaps with the microresonator.
Example 27 includes the subject matter of Example 26, and wherein the PIC die further comprises a semiconductor junction that at least partially overlaps with the microresonator.
Example 28 includes the subject matter of any of Examples 26 and 27, and further including control circuitry to control a voltage across the variable optical attenuator to control a quality factor of the microresonator.
Example 29 includes the subject matter of any of Examples 26-28, and further including control circuitry to determine a desired coupling regime between the waveguide and the microresonator; and control a voltage across the variable optical attenuator at least partially based on the desired coupling regime.
Example 30 includes the subject matter of any of Examples 26-29, and wherein to determine a desired coupling regime between the waveguide and the microresonator comprises to determine that a critical coupling regime between the waveguide and the microresonator is desired, wherein to control the voltage across the variable optical attenuator comprises to control the voltage across the variable optical attenuator to control a coupling regime between the waveguide and the microresonator to be at about critical coupling.
Example 31 includes the subject matter of any of Examples 26-30, and further including control circuitry to determine a desired chirp on light in the waveguide; and control a voltage across the variable optical attenuator at least partially based on the desired chirp on light in the waveguide.
Example 32 includes the subject matter of any of Examples 26-31, and further including control circuitry to determine a desired tradeoff between optical bandwidth of the microresonator and a modulation speed of the microresonator; and control a voltage across the variable optical attenuator at least partially based on the desired tradeoff between optical bandwidth of the microresonator and a modulation speed of the microresonator.
Example 33 includes the subject matter of any of Examples 26-32, and wherein the PIC die further comprises a second waveguide; a second microresonator coupled to the second waveguide; a second variable optical attenuator that at least partially overlaps with the second microresonator; and control circuitry to control a voltage across the variable optical attenuator and a voltage across the second variable optical attenuator to match a first coupling regime between the waveguide and the microresonator and a second coupling regime between the second waveguide and the second microresonator.
Example 34 includes the subject matter of any of Examples 26-33, and further including control circuitry to determine an amount of a redshift of a resonance the microresonator due to baseline wandering; and control a voltage across the variable optical attenuator to impart a blueshift on the resonance of the microresonator to at least partially offset the redshift of the resonance of the microresonator due to baseline wandering.
Example 35 includes the subject matter of any of Examples 26-34, and wherein the waveguide is a first material, wherein the microresonator is a second material different from the first material.
Example 36 includes the subject matter of any of Examples 26-35, and wherein the first material comprises silicon and nitrogen, wherein the second material comprises gallium and arsenic.
Example 37 includes the subject matter of any of Examples 26-36, and wherein the waveguide comprises silicon and nitrogen.
Example 38 includes the subject matter of any of Examples 26-37, and wherein the microresonator comprises gallium and arsenic.
Example 39 includes the subject matter of any of Examples 26-38, and wherein the microresonator comprises indium and phosphorous.
Example 40 includes the subject matter of any of Examples 26-39, and wherein the variable optical attenuator is a P-I-N junction.
Example 41 includes the subject matter of any of Examples 26-40, and further including a second variable optical attenuator.
Example 42 includes the subject matter of any of Examples 26-41, and further including control circuitry to control a voltage of the variable optical attenuator to control a quality factor of the microresonator; and control a voltage of the second variable optical attenuator to control an amount of blueshift of a resonance of the microresonator.
Example 43 includes the subject matter of any of Examples 26-42, and further including a second waveguide, wherein the second waveguide is coupled to the microresonator.
Example 44 includes the subject matter of any of Examples 26-43, and wherein the microresonator is a microring resonator.
Example 45 includes the subject matter of any of Examples 26-44, and wherein the microresonator is a racetrack resonator.
Example 46 includes the subject matter of any of Examples 26-45, and further including a heater thermally coupled to the microresonator.
Example 47 includes the subject matter of any of Examples 26-46, and further including an integrated circuit package, wherein the integrated circuit package comprises the PIC die, a substrate, and an electronic integrated circuit (EIC) die.
Example 48 includes an apparatus comprising a photonic integrated circuit (PIC) die comprising a waveguide; a microresonator coupled to the waveguide; means for modulating a resonance frequency of the microresonator; and means for reducing a quality factor of the microresonator.
Example 49 includes the subject matter of Example 48, and further including control circuitry to control a voltage across the means for modulating a resonance frequency to control a resonance frequency of the microresonator; and control a voltage across the means for reducing a quality factor to control a quality factor of the microresonator.
Example 50 includes the subject matter of any of Examples 48 and 49, and further including control circuitry to reverse bias the means for modulating a resonance frequency; and forward bias the means for reducing a quality factor.
Example 51 includes the subject matter of any of Examples 48-50, and further including control circuitry to determine a desired coupling regime between the waveguide and the microresonator; and control a voltage across the means for reducing a quality factor at least partially based on the desired coupling regime.
Example 52 includes the subject matter of any of Examples 48-51, and wherein to determine a desired coupling regime between the waveguide and the microresonator comprises to determine that a critical coupling regime between the waveguide and the microresonator is desired, wherein to control the voltage across the means for reducing a quality factor comprises to control the voltage across the means for reducing a quality factor to control a coupling regime between the waveguide and the microresonator to be at about critical coupling.
Example 53 includes the subject matter of any of Examples 48-52, and further including control circuitry to determine a desired chirp on light in the waveguide; and control a voltage across the means for reducing a quality factor at least partially based on the desired chirp on light in the waveguide.
Example 54 includes the subject matter of any of Examples 48-53, and further including control circuitry to determine a desired tradeoff between optical bandwidth of the microresonator and a modulation speed of the microresonator; and control a voltage across the means for reducing a quality factor at least partially based on the desired tradeoff between optical bandwidth of the microresonator and a modulation speed of the microresonator.
Example 55 includes the subject matter of any of Examples 48-54, and wherein the PIC die further comprises a second waveguide; a second microresonator coupled to the second waveguide; second means for modulating a resonance frequency of the microresonator; second means for reducing a quality factor of the microresonator; and control circuitry to control a voltage across the means for reducing a quality factor and a voltage across the second means for reducing a quality factor to match a first coupling regime between the waveguide and the microresonator and a second coupling regime between the second waveguide and the second microresonator.
Example 56 includes the subject matter of any of Examples 48-55, and further including control circuitry to determine an amount of a redshift of a resonance the microresonator due to baseline wandering; and control a voltage across the means for reducing a quality factor to impart a blueshift on the resonance of the microresonator to at least partially offset the redshift of the resonance of the microresonator due to baseline wandering.
Example 57 includes the subject matter of any of Examples 48-56, and wherein the waveguide is a first material, wherein the microresonator is a second material different from the first material.
Example 58 includes the subject matter of any of Examples 48-57, and wherein the first material comprises silicon and nitrogen, wherein the second material comprises gallium and arsenic.
Example 59 includes the subject matter of any of Examples 48-58, and wherein the waveguide comprises silicon and nitrogen.
Example 60 includes the subject matter of any of Examples 48-59, and wherein the microresonator comprises gallium and arsenic.
Example 61 includes the subject matter of any of Examples 48-60, and wherein the microresonator comprises indium and phosphorous.
Example 62 includes the subject matter of any of Examples 48-61, and wherein the means for modulating a resonance frequency is a P-N junction, wherein the means for reducing a quality factor is a P-I-N junction.
Example 63 includes the subject matter of any of Examples 48-62, and further including second means for reducing a quality factor of the microresonator.
Example 64 includes the subject matter of any of Examples 48-63, and further including control circuitry to control a reverse bias of the means for modulating a resonance frequency to modulate a resonance frequency of the microresonator; control a forward bias of the means for reducing a quality factor to control a quality factor of the microresonator; and control a forward bias of the second means for reducing a quality factor of the microresonator to control an amount of blueshift of a resonance of the microresonator.
Example 65 includes the subject matter of any of Examples 48-64, and wherein the microresonator comprises an isolation region between the means for modulating a resonance frequency and the means for reducing a quality factor.
Example 66 includes the subject matter of any of Examples 48-65, and wherein the isolation region comprises a plurality of alternating p-doped and n-doped regions.
Example 67 includes the subject matter of any of Examples 48-66, and wherein the microresonator comprises an outer edge and an inner edge, wherein the means for modulating a resonance frequency comprises a p-doped region at least partially along the outer edge and an n-doped region at least partially along the inner edge, wherein the means for reducing a quality factor comprises an n-doped region at least partially along the outer edge and a p-doped region at least partially along the inner edge.
Example 68 includes the subject matter of any of Examples 48-67, and further including a second waveguide, wherein the second waveguide is coupled to the microresonator.
Example 69 includes the subject matter of any of Examples 48-68, and wherein the microresonator is a microring resonator.
Example 70 includes the subject matter of any of Examples 48-69, and wherein the microresonator is a racetrack resonator.
Example 71 includes the subject matter of any of Examples 48-70, and further including a heater thermally coupled to the microresonator.
Example 72 includes the subject matter of any of Examples 48-71, and further including an integrated circuit package, wherein the integrated circuit package comprises the PIC die, a substrate, and an electronic integrated circuit (EIC) die.

1. An apparatus comprising:
a photonic integrated circuit (PIC) die comprising:
a waveguide;
a microresonator coupled to the waveguide;
a first semiconductor junction that at least partially overlaps with the microresonator; and
a second semiconductor junction that at least partially overlaps with the microresonator.

2. The apparatus of claim 1, further comprising control circuitry to:
control a voltage across the first semiconductor junction to control a resonance frequency of the microresonator; and
control a voltage across the second semiconductor junction to control a quality factor of the microresonator.

3. The apparatus of claim 1, further comprising control circuitry to:
reverse bias the first semiconductor junction; and
forward bias the second semiconductor junction.

4. The apparatus of claim 1, further comprising control circuitry to:
determine a desired coupling regime between the waveguide and the microresonator; and
control a voltage across the second semiconductor junction at least partially based on the desired coupling regime.

5. The apparatus of claim 1, further comprising control circuitry to:
determine a desired chirp on light in the waveguide; and
control a voltage across the second semiconductor junction at least partially based on the desired chirp on light in the waveguide.

6. The apparatus of claim 1, further comprising control circuitry to:
determine a desired tradeoff between optical bandwidth of the microresonator and a modulation speed of the microresonator; and
control a voltage across the second semiconductor junction at least partially based on the desired tradeoff between optical bandwidth of the microresonator and a modulation speed of the microresonator.

7. The apparatus of claim 1, wherein the PIC die further comprises:
a second waveguide;
a second microresonator coupled to the second waveguide;
a third semiconductor junction that at least partially overlaps with the second microresonator;
a fourth semiconductor junction that at least partially overlaps with the second microresonator; and
control circuitry to:
control a voltage across the second semiconductor junction and a voltage across the fourth semiconductor junction to match a first coupling regime between the waveguide and the microresonator and a second coupling regime between the second waveguide and the second microresonator.

8. The apparatus of claim 1, further comprising control circuitry to:
determine an amount of a redshift of a resonance the microresonator due to baseline wandering; and
control a voltage across the second semiconductor junction to impart a blueshift on the resonance of the microresonator to at least partially offset the redshift of the resonance of the microresonator due to baseline wandering.

9. The apparatus of claim 1, wherein the waveguide comprises silicon and nitrogen, wherein the microresonator comprises gallium and arsenic.

10. The apparatus of claim 1, wherein the microresonator comprises an isolation region between the first semiconductor junction and the second semiconductor junction.

11. The apparatus of claim 10, wherein the isolation region comprises a plurality of alternating p-doped and n-doped regions.

12. The apparatus of claim 1, further comprising an integrated circuit package, wherein the integrated circuit package comprises the PIC die, a substrate, and an electronic integrated circuit (EIC) die.

13. An apparatus comprising:
a photonic integrated circuit (PIC) die comprising:
a waveguide;
a microresonator coupled to the waveguide; and
a variable optical attenuator that at least partially overlaps with the microresonator.

14. The apparatus of claim 13, further comprising control circuitry to:
control a voltage across the variable optical attenuator to control a quality factor of the microresonator.

15. The apparatus of claim 13, further comprising control circuitry to:
determine an amount of a redshift of a resonance the microresonator due to baseline wandering; and
control a voltage across the variable optical attenuator to impart a blueshift on the resonance of the microresonator to at least partially offset the redshift of the resonance of the microresonator due to baseline wandering.

16. An apparatus comprising:
a photonic integrated circuit (PIC) die comprising:
a waveguide;
a microresonator coupled to the waveguide;
means for modulating a resonance frequency of the microresonator; and
means for reducing a quality factor of the microresonator.

17. The apparatus of claim 16, further comprising control circuitry to:
control a voltage across the means for modulating a resonance frequency to control a resonance frequency of the microresonator; and
control a voltage across the means for reducing a quality factor to control a quality factor of the microresonator.

18. The apparatus of claim 16, further comprising control circuitry to:
reverse bias the means for modulating a resonance frequency; and
forward bias the means for reducing a quality factor.

19. The apparatus of claim 16, further comprising control circuitry to:
determine a desired coupling regime between the waveguide and the microresonator; and
control a voltage across the means for reducing a quality factor at least partially based on the desired coupling regime.

20. The apparatus of claim 16, further comprising control circuitry to:
determine a desired chirp on light in the waveguide; and
control a voltage across the means for reducing a quality factor at least partially based on the desired chirp on light in the waveguide;
resonance of the microresonator to at least partially offset the redshift of the resonance of the microresonator due to baseline wandering.
